(19) United States
(12) Patent Application Publication
(10) Pub. No.: US 2023/0015679 A1
(43) Pub. Date: Jan. 19, 2023

(54) Scallop Feeder Bowl and Delivery System for Necked Bottles and like objects

(71) Applicant: Greg Schombert, Knightstown, IN (US)

(72) Inventor: Greg Schombert, Knightstown, IN (US)

(21) Appl. No.: 17/857,014

(22) Filed: Jul. 3, 2022

Related U.S. Application Data
(60) Provisional application No. 63/220,058, filed on Jul. 9, 2021.

(51) Int. Cl. B65G 47/256

(52) U.S. Cl. CPC B65G 47/256; B65G 2201/0244

(57) ABSTRACT

An apparatus and system with a compact footprint and floor space requirements, reduced changeover time for product tooling changeover, reduced labor, smaller initial capital investments, and reduced waste while increasing overall machine uptime/usage, productivity, quality/repeatability, and reducing spare parts inventory and maintenance. This apparatus and system is a Scallop Feeder Bowl and Delivery System for Necked Bottles and like objects. The main function of this design is to build a machine with completely interchangeable pieces for multiple parts handling including first interchangeable upper parts with an upper scallop and a pre-scallop section has interchangeable sections allow for multiple parts with easy changeover and second an interchangeable lower and supporting parts with a lower scallop and a series of custom drop funnel sections.

### CROSS-REFERENCE TO RELATED APPLICATIONS

This application claims the benefit of U.S. Provisional Patent Application with Ser. No. 63/220,058 filed Jul. 9, 2021, by Greg Schombert. The application is entitled “A Scallop Feeder Bowl and Delivery System for Necked Bottles and like objects”.

### FIELD OF INVENTION

This invention relates to a container feeder device and system. Particularly it relates to a Scallop Feeder Bowl and Delivery System for Necked Bottles and like objects. The present disclosure relates generally to the preparation, orientation and handling various sized bottles and object with one base machine. It also relates to an apparatus or system that incorporates a system that automates the process. The present invention relates to a clean product aligning device made of food grade and cleanable grade materials that are easily disassembled and able to be washed in hot water and steam. It relates to a system that is a singulating system that significantly reduces time, labor, spare parts, capital investment, and waste while increasing productivity, quality, and machine uptime.

### FEDERALLY SPONSORED RESEARCH

None.

### SEQUENCE LISTING OR PROGRAM

None.

### BACKGROUND

### Field of Invention and Prior Art

This section is not Applicable to Provisional Applications. However, as far as known, there are no Scallop Feeder Bowl and Delivery System for Necked Bottles and like objects. It is believed that this product is unique in its design and technologies.

### Background

This background as to feeder systems for bottles and like objects are that they have been labor intensive. And the industry tended to build a unique machine for each sized container. Therefore, machines sat idle when one sized bottle was run. The added machines cost additional capital, required spare parts, and often were built at different times with different designs and/or manufactures of the tooling and equipment. That forced more spare parts, added training for the tool and maintenance people and generally hampered repeatability and good training of the workforce. A significant portion of the cost of manufacturing certain products is from the processing of the containers that hold the products and more specifically orient the containers through the product manufacturing.

In some other industries, various parts or products are placed into containers that have health, sterile, cleanability, and other stringent handling and preparation requirements. Therefore, machines need to be cleanable, made of durable materials and easy to assemble and dis-assemble for tool and product change over as well as the hygienic/cleanability needs. Centrifugal precision feeders can be developed to aid in this process, but they must be manufactured from a high grade and hygienic grade materials. The unoriented containers, parts, bottles, and objects can be then oriented and are transferred and eventually fed to a next station. In the past, quite often the equipment must have been individually designed and built for the intended product to be packaged in the containers. The equipment must be capable of receiving containers and bottles in bulk, separating, or segregating them for the desired sizes and preparing and orienting the containers for filling and labelling, and ultimately packaging the product for shipment. The equipment must be capable of handling large quantities of the containers and be changed quickly for the next size in a very fast manner to work efficiently and competitively with product and packaging operations.

### Problem Solved

The improvement and problem solved is therefore is an apparatus and system with a compact footprint and floor space requirements, reduced changeover time (product tooling changeover), reduced labor, smaller initial capital investments, and reduced waste while increasing overall machine uptime/usage, productivity, and quality (repeatability) and reducing spare parts inventory and maintenance (training and understanding of equipment).

### Prior Art

A novelty search was completed for the orientation and feeding of necked bottles and other items with a versatile scallop feeder bowl or equivalent machine. The search included the following:
A. U.S. Pat. No. 7,331,152 called a Beverage bottling plant for filling beverage bottles having a beverage bottle orientation and positioning arrangement that was issued to Menke in 2008. Provided here is a beverage bottling plant for filling beverage bottles having a beverage bottle orientation and positioning arrangement. The orientation and positioning arrangement includes the use of cameras, and an evaluation and control system. A first camera is configured and disposed to scan the external or peripheral surface of the beverage bottle over a wide area. A second camera is configured and disposed to scan the external or peripheral surface of the beverage bottle over a narrower area than the first camera.
B. U.S. Pat. No. 4,844,233 named a Bottle Orientation Apparatus and Method that was issued in 1089 to Aidlin et al. Shown is a bottle orientation system for orientating and up-righting a horizontal flow of bottles being conveyed by co-acting endless belt conveyors. The system includes a raised kick-up stop and knock-down stop for positioning all bottles in a bottom-first position between the belts. A raised platform then rights the bottles between the belts.
C. U.S. Publication 2010/0108466 titled a Bottle Orienting device and submitted by Herzog. Demonstrated here is a bottle orienting device for orienting bottles including a neck with an opening on one end thereof in accordance with an embodiment of the present application includes a first belt operable to advance a bottle in a first direction, a stationary kicker extending upward relative to a lower surface of the bottle as it moves in the first direction and positioned in a path of travel of the bottle such that the bottle will rotate around the kicker as it passes the kicker, and a rotation deflector positioned above the kicker and upstream from the kicker, the rotation deflector positioned such that it prevents rotation of the bottle when desired.
D. A Chinese publication CN101863375A called a Directional arrangement mechanism of neck protruding bottle submitted in 2010. Shown is a directional arrangement mechanism of a neck protruding bottle, which is provided with a bottle-feeding device, and is characterized in that the end part of the bottle feeding device is provided with a plurality of supporting rods, the distance between two adjacent supporting rods is matched with the outer diameter of the bottle and is less than the outside diameter of the protrusion at the neck of the bottle. In the invention, the bottle-feeding device feeds the neck protruding bottle to the position between two supporting rods, the characteristics of the neck protrusion of bottle and bottle self-weight are utilized, the bottle body falls into a space between the two supporting rods while the neck protrusion of the bottle is clamped between the two supporting rods, thus the direction of chaotic bottles can be uniformed to facilitate subsequent process operations.
E. A French patent FR2976571known as a Bottle orientation installation issued in 2014 to Didier Gouelibo. Provided here is an installation for the orientation of bottles, in particular with a view to improving traceability, comprising:—a device for marking and/or identifying bottles, in particular in order to mark and/or identify before labeling, and—a conveying system, comprising a bottle orientation mechanism to bring them with a predefined orientation in front of said marking device and/or identification.
F. A Japanese patent JP6565171 issued in 2014 was named a Container transfer control device. Taught here is a filling processing system including a blow molding machine, and more particularly to an apparatus for controlling a conveyance path of a container to be filled.

As can be observed, none of the prior art has anticipated or caused one skilled in the feeding and orienting necked bottles and like objects anticipate or render this invention as obvious to one skilled in the industry. The Scallop Feeder Bowl and Delivery System provides an answer to a compact, versatile, clean, and fast manner to organized, align, and singularly feed the objects.

### SUMMARY OF THE INVENTION

This invention is a Scallop Feeder Bowl and Delivery System for Necked Bottles and like objects. The main function of this design is to build a machine with completely interchangeable pieces for multiple parts handling.
A. Interchangeable upper parts
   1. Upper Scallop
   2. Pre-scallop section has interchangeable sections allow for multiple parts with easy changeover
B. Interchangeable lower and supporting parts
   1. Lower Scallop
   2. Custom drop funnel sections

The preferred embodiment of a Scallop feeder bowl and delivery system 30 for a group of un-oriented, necked bottles 100 and like objects, the system 30 is comprised of: a) a set of interchangeable upper parts including—a set of Upper Scallops which have interchangeable sections and a set of Pre-scallop section which have interchangeable sections that allow for multiple parts unique to each bottle/object size; b) a set of interchangeable lower and supporting parts including—a set of Lower Scallops which have interchangeable parts, a set of custom drop funnel sections, a set of Extractor tooling sections, and a Steel ring inhibitor wherein the system is built with completely interchangeable pieces for multiple parts handling, the system results in reduced changeover time (product tooling changeover), labor, initial capital investments, floor space requirements, spare parts inventory, maintenance (training and understanding of equipment), and waste, and the system increased overall machine uptime/usage, productivity, quality (repeatability).

And an alternative embodiment is a Scallop feeder bowl and delivery system 30 for a group of un-oriented, necked bottles 100 and like objects, the process used in the system 30 is comprised of: Step 200: un-oriented bottle 100 entry 200 from feeder conveyors 109;
Step 210: un-oriented bottles 100 drop 210 to rigid disk 35;
Step 220: un-oriented bottles 100 advance 220 across pre scallops 81 toward upper scallops 41 ;
Step 230: un-oriented bottles 100 drop 230 into aperture 46 of upper scallop 41;
Step 240: un-oriented bottles 100 drop 240 up righted, oriented 105 between lower scallops 51 into space 51S;
Step 250: up-righted bottles, oriented 105 continue drop 250 between lower scallops 51 to ring 63;
Step 260: oriented bottles 105 advance 260 through drop funnel 61;
Step 270: oriented bottles 105 advance 270 through extractor tooling 71; and
Step 280: oriented bottles 105 advance 280 from scallop feeder 31 to next machine (wash, fill etc.)
   wherein the system is built with completely interchangeable pieces for multiple parts handling, the system results in reduced changeover time (product tooling changeover), labor, initial capital investments, floor space requirements, spare parts inventory, maintenance (training and understanding of equipment), and waste, and the system increased overall machine uptime/usage, productivity, quality (repeatability).

### OBJECTS AND ADVANTAGES

There are several objects and advantages of the This invention is a Scallop feeder bowl and delivery system 30 for necked bottles 100 and like objects in Table A:

| Item | Advantages |
|---|---|
| 1 | reduces changeover time (product tooling |
| | changeover) |
| 2 | increases output rate and productivity (reduces |
| | labor) |
| 3 | reduces floor space requirements and provide a |
| | compact footprint |
| 4 | reduces initial capital investments |
| 5 | reduces waste |
| 6 | increases uptime of the equipment with versatile |
| | multipart usage and fast changeover |
| 7 | increases quality (repeatability) |
| 8 | reduces spare parts inventory |
| 9 | reduces maintenance (training and understanding |
| | of equipment). |
| 10 | is easy to use and maintain |

Finally, other advantages and additional features of the present Scallop Feeder Bowl and Delivery System for Necked Bottles and like objects will be more apparent from the accompanying drawings and from the full description of the device. For one skilled in the art of feeder machines and orientation equipment for oddly configured parts like necked bottles, it is readily understood that the features shown in the examples with this scallop feeder bowl and delivery system are readily adapted to other types of processing for bottle and like objects orientation equipment and tools.

### DESCRIPTION OF THE DRAWINGS

### Figures

The accompanying drawings, which are incorporated in and constitute a part of this specification, illustrate an embodiment of the Scallop Feeder Bowl and Delivery System for Necked Bottles and like objects. The drawings together with the summary description given above and a detailed description given below explain the principles of the Scallop Feeder Bowl and Delivery System. It is understood, however, that the feeding device and system is not limited to only the precise arrangements and instrumentalities shown.

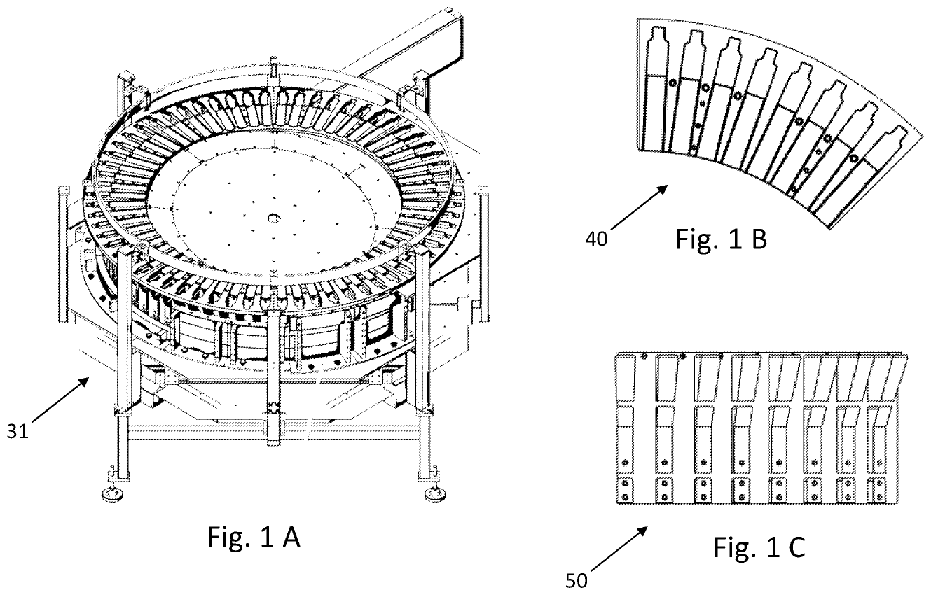

FIGS. 1A through 1C are sketches of the general Scallop Feeder Bowl and Delivery System for Necked Bottles and like objects plus sketches of an upper and lower scallop section.

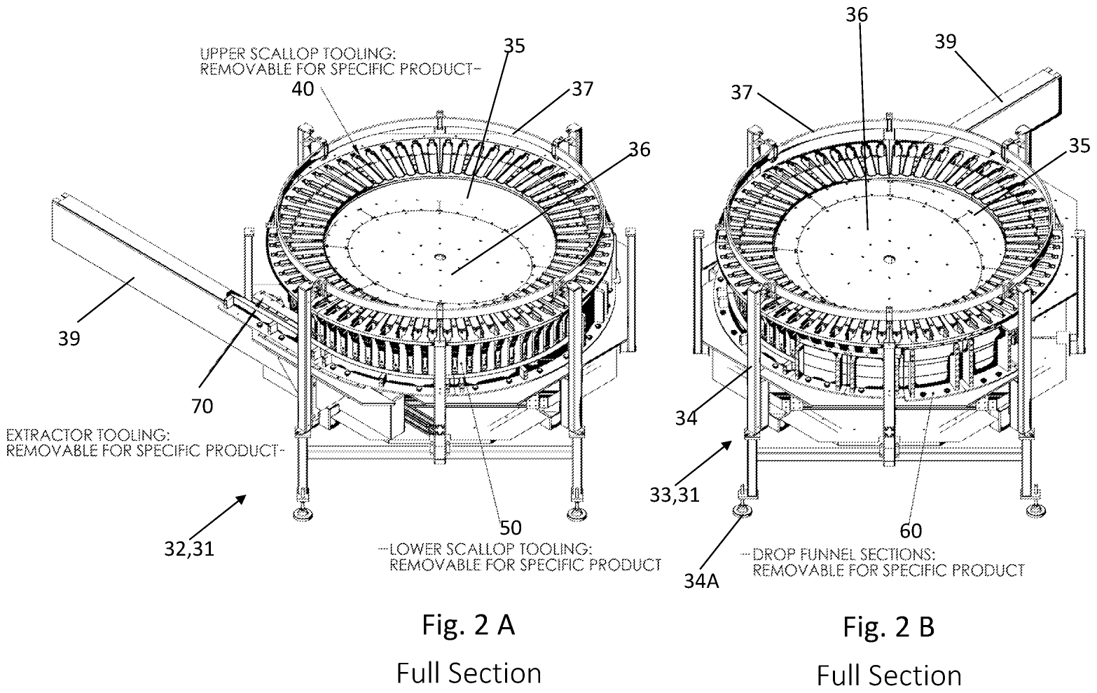

FIGS. 2A and 2B are front and back views of the Scallop Feeder Bowl and Delivery System for Necked Bottles and like objects with components and features noted.

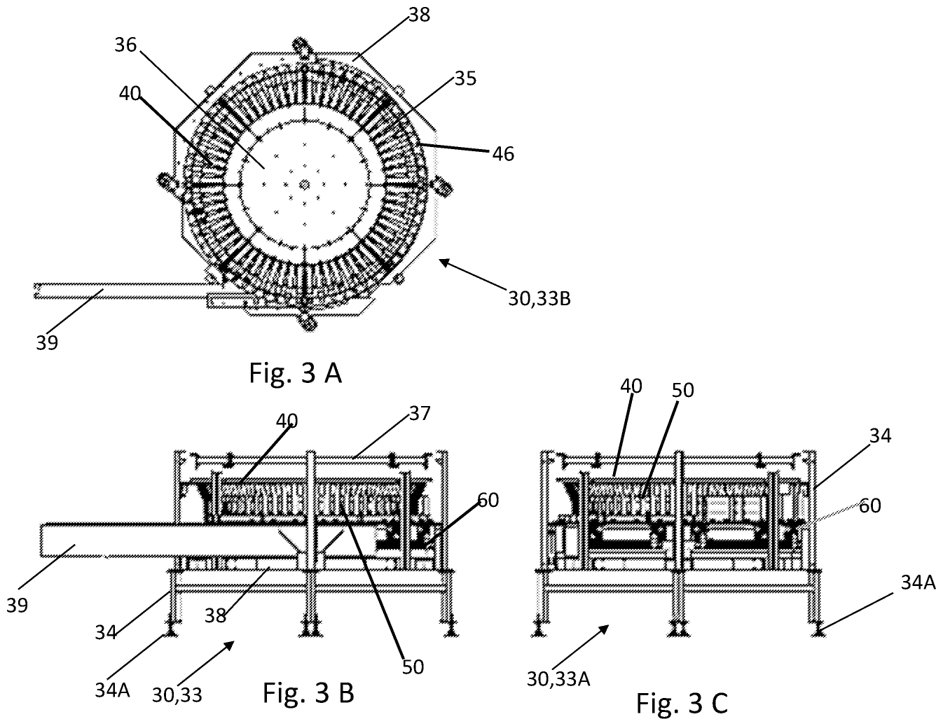

FIGS. 3A through 3C are sketches of the Top, front and side views of the Scallop Feeder Bowl and Delivery System for Necked Bottles and like objects with components and features noted.

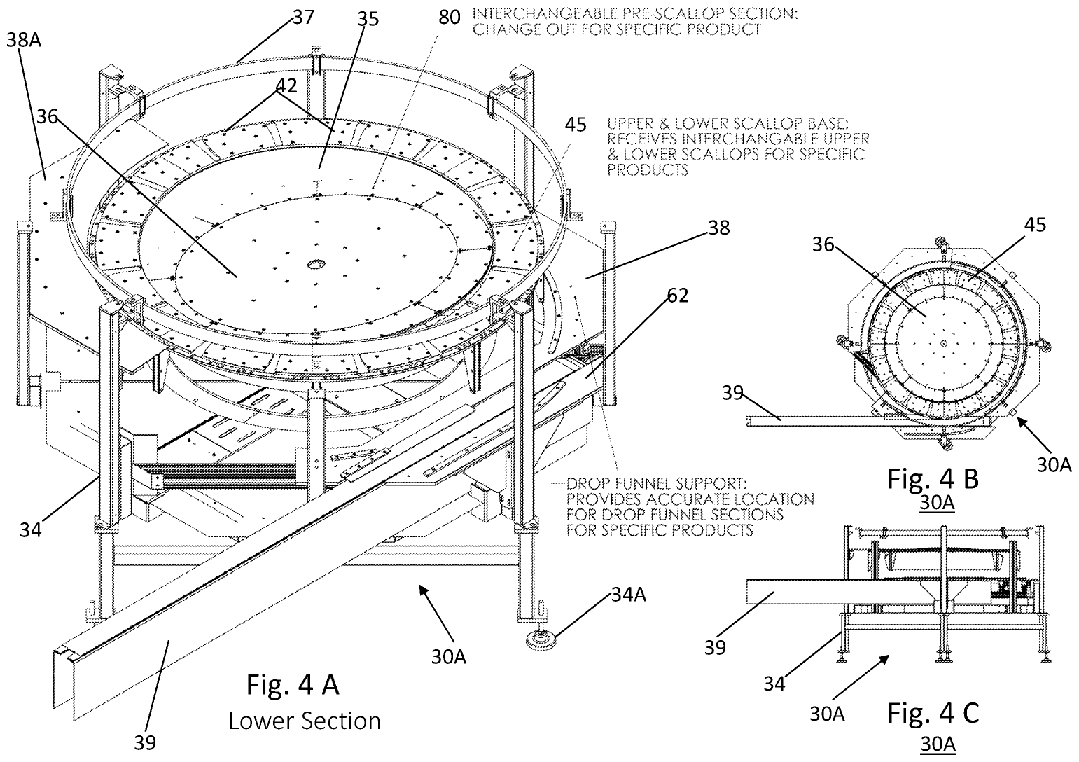

FIGS. 4A through 4C are sketches of the lower sections isometric, top and side views of the Scallop Feeder Bowl and Delivery System for Necked Bottles and like objects with components and features noted.

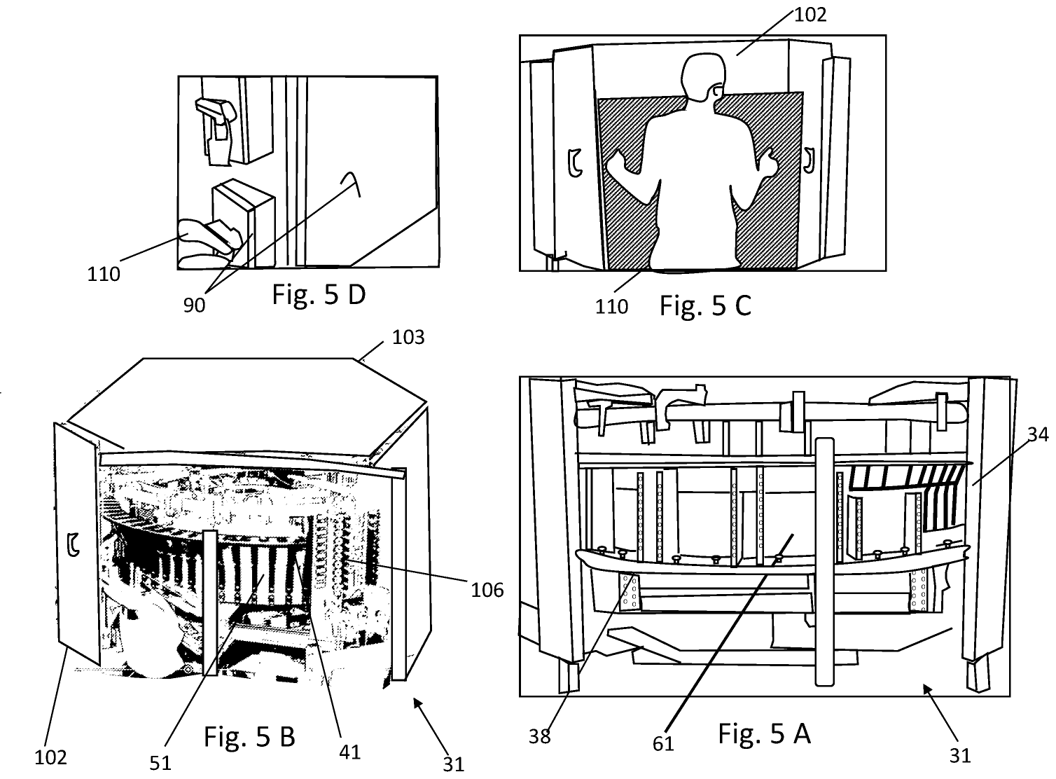

FIGS. 5A through 5D are sketches and photos of the prototype Scallop Feeder Bowl and Delivery System for Necked Bottles and like objects with components and features noted.

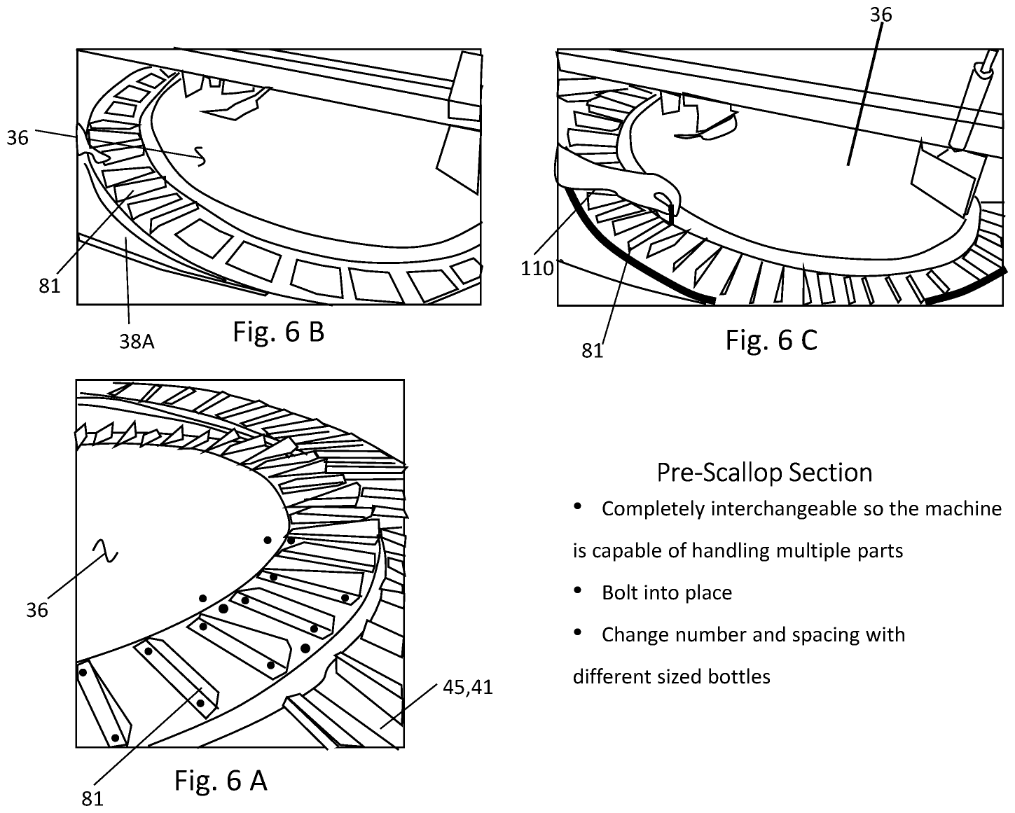

FIGS. 6A through 6C are sketches of Pre scallop sections of the Scallop Feeder Bowl and Delivery System where the bottles and objects first enter the bowl from an un-oriented conveyor.

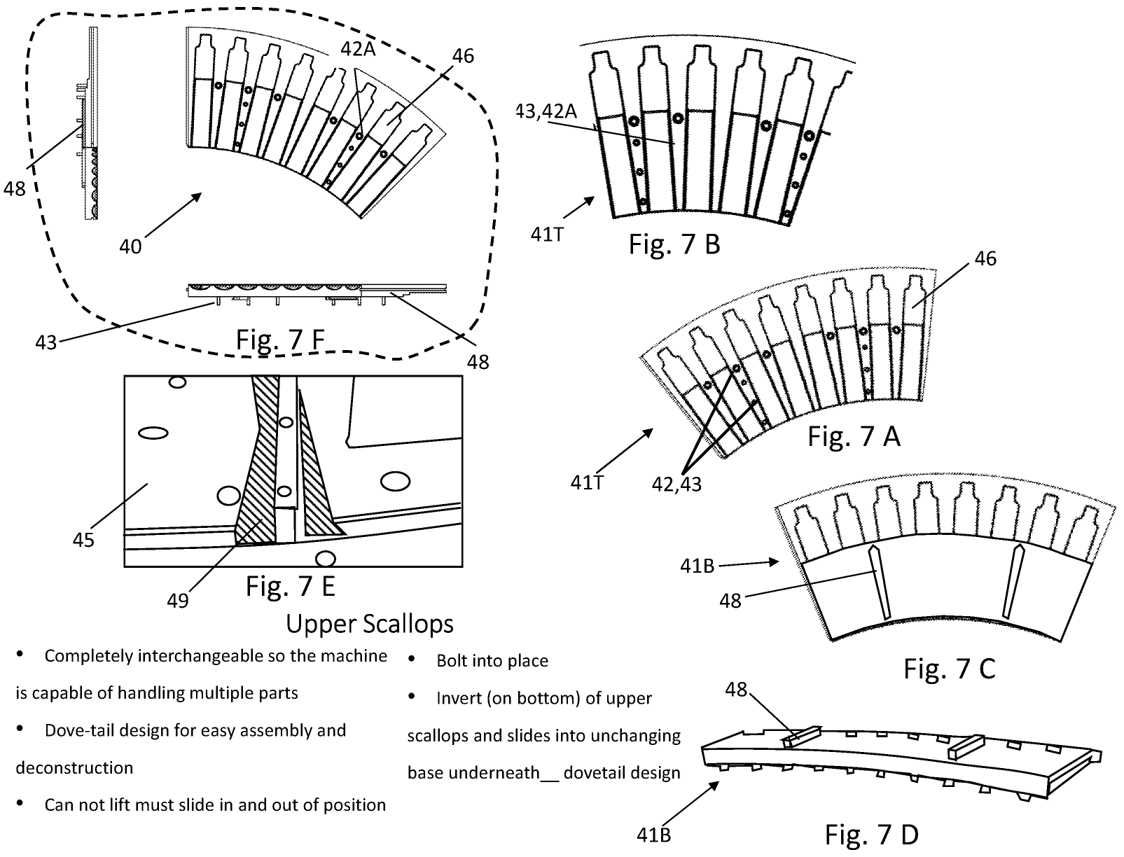

FIGS. 7A through 7F are sketches of the upper scallops with features and components noted.

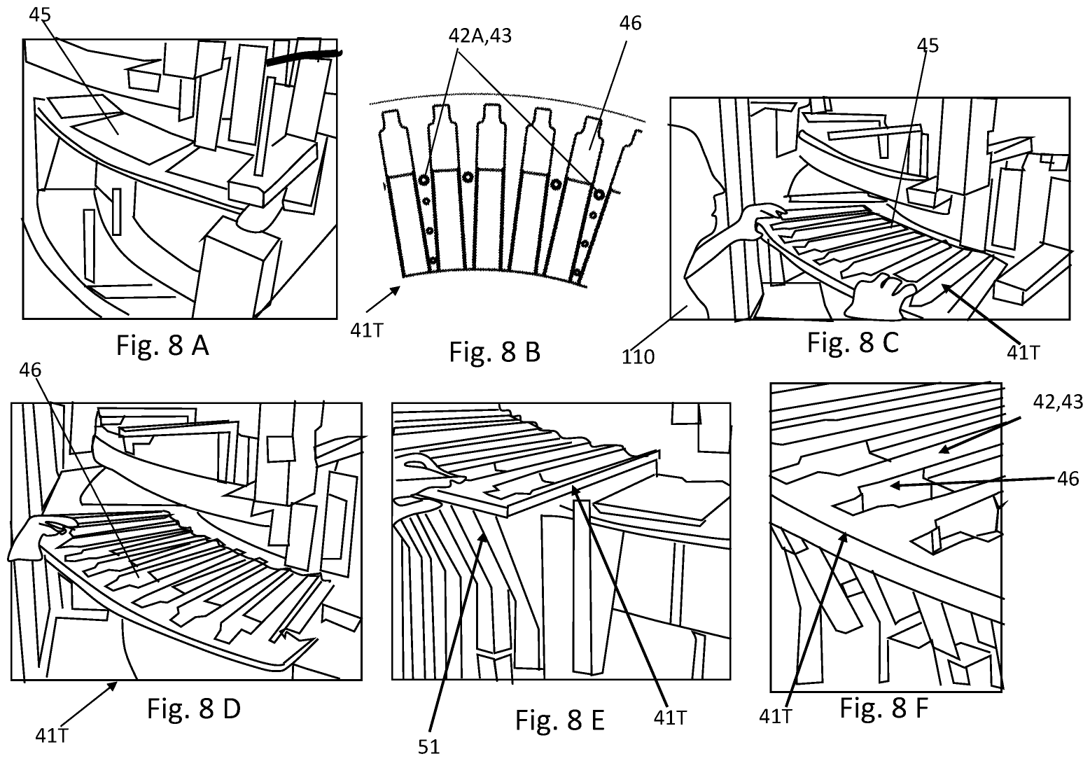

FIGS. 8A through 8F are sketches and photos of the prototype upper scallops with features and components noted.

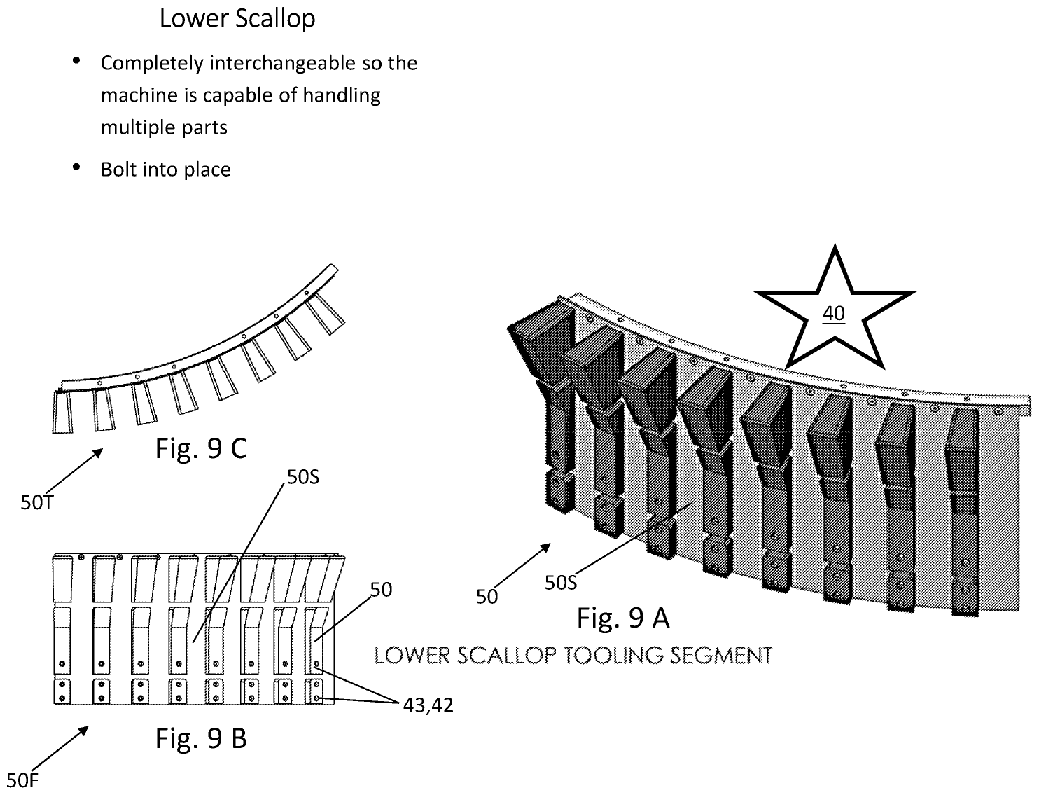

FIGS. 9A through 9C are sketches of the lower scallops with features and components noted.

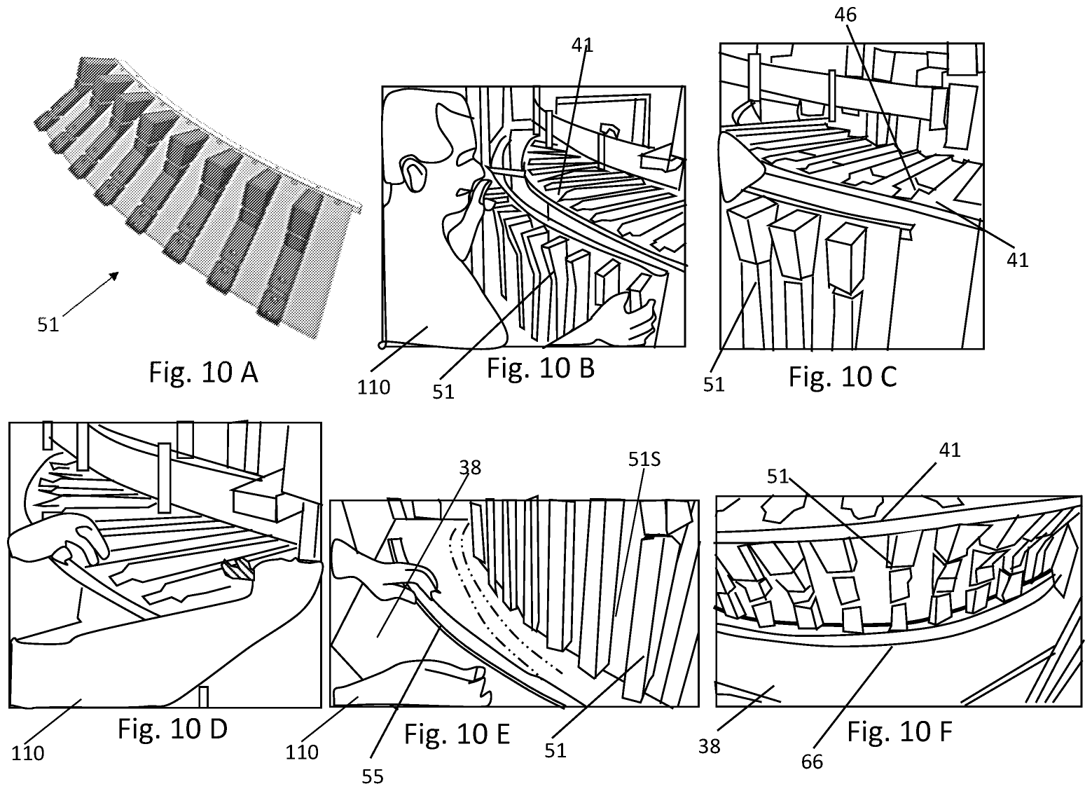

FIGS. 10A through 10F are sketches and photos of the prototype lower scallops with features and components noted.

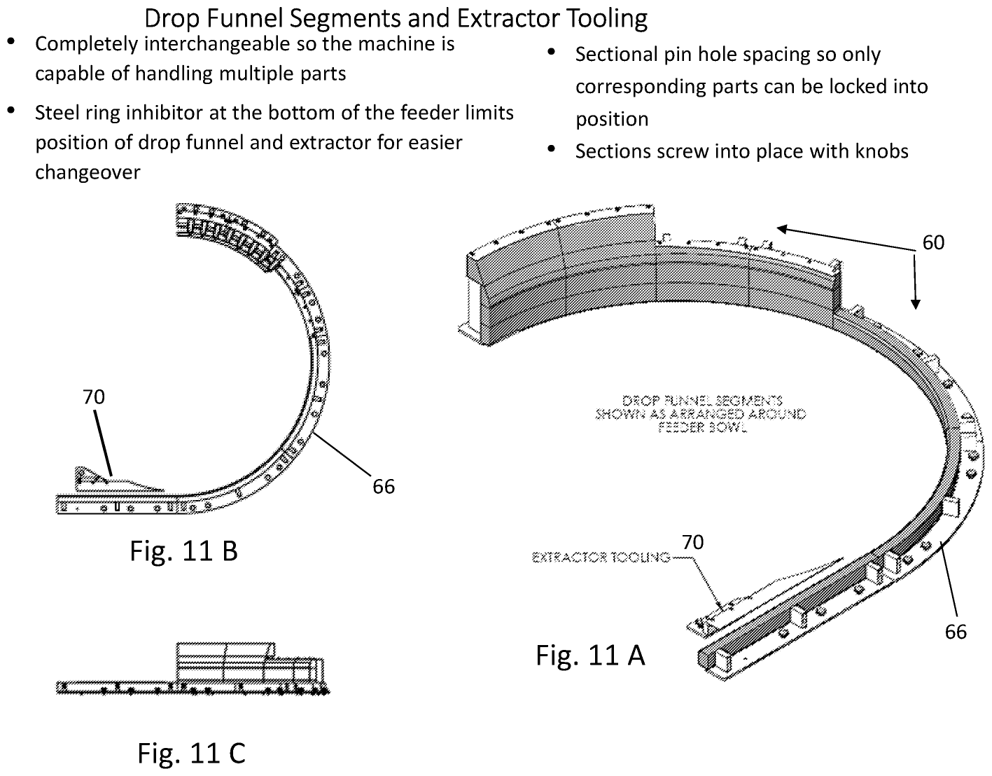

FIGS. 11A through 11C are sketches of the Drop Funnel Segments and Extractor Tooling with features and components noted.

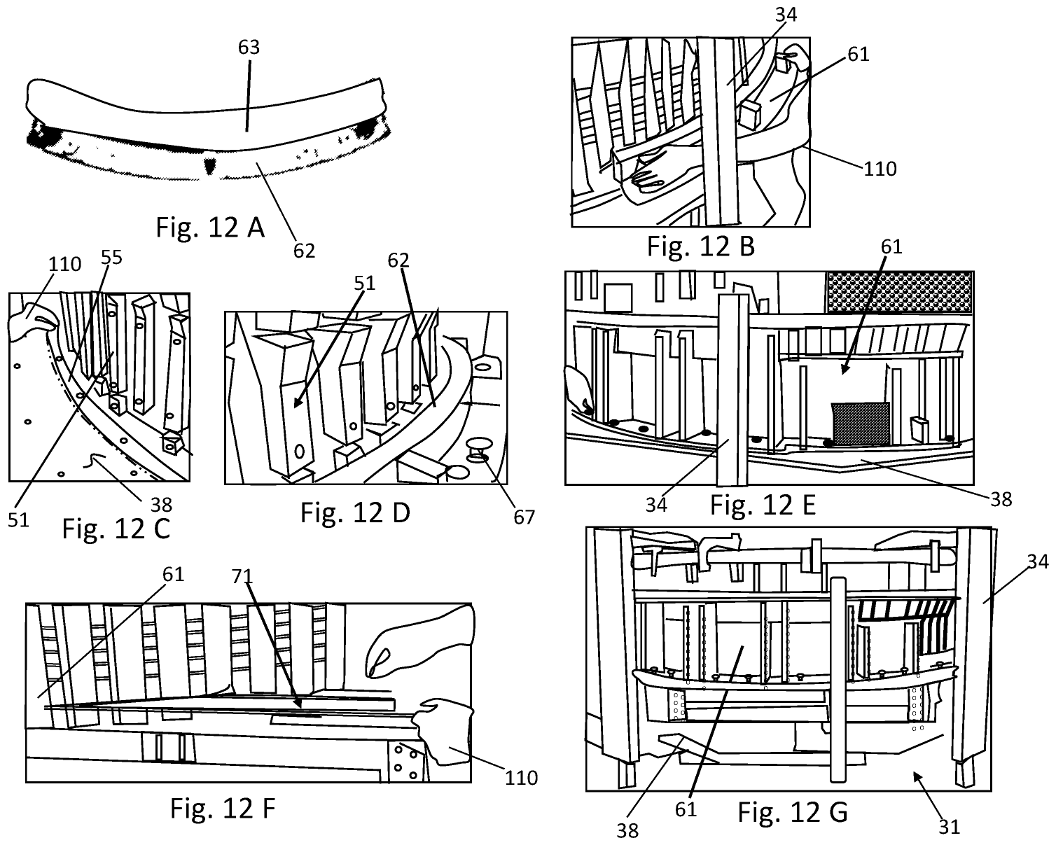

FIGS. 12A through 12G are sketches and photos of the prototype Drop Funnel Segments and Extractor Tooling with features and components noted.

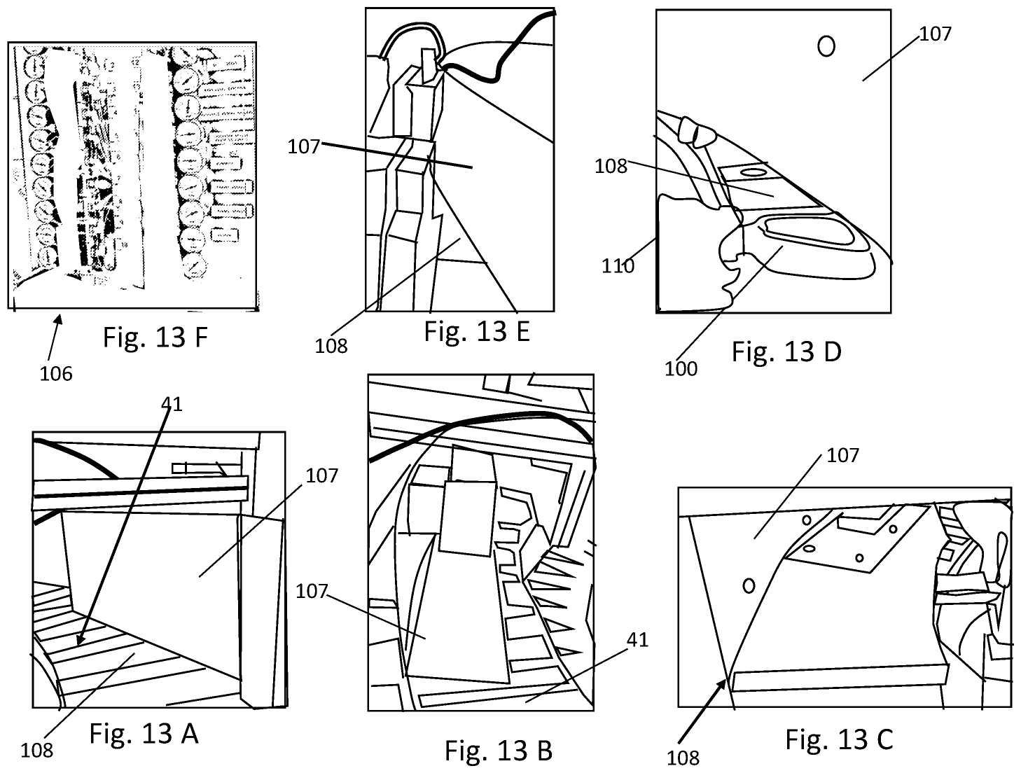

FIGS. 13A through 13F are sketches and photos of the prototype qualifiers as cam slides to divert and select properly oriented bottles and objects with features and components noted.

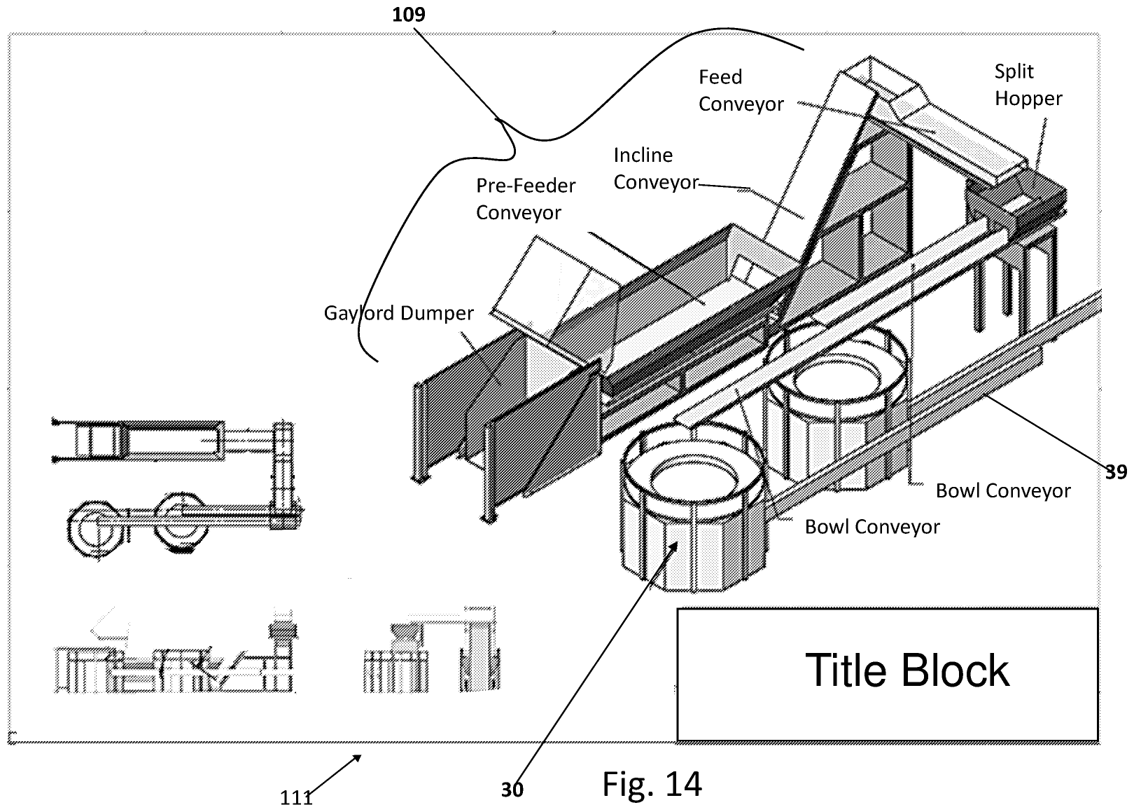

FIG. 14 is a sketch of the feeder conveyors and system to the Scallop Feeder Bowl and Delivery System for Necked Bottles and like objects with features and components noted.

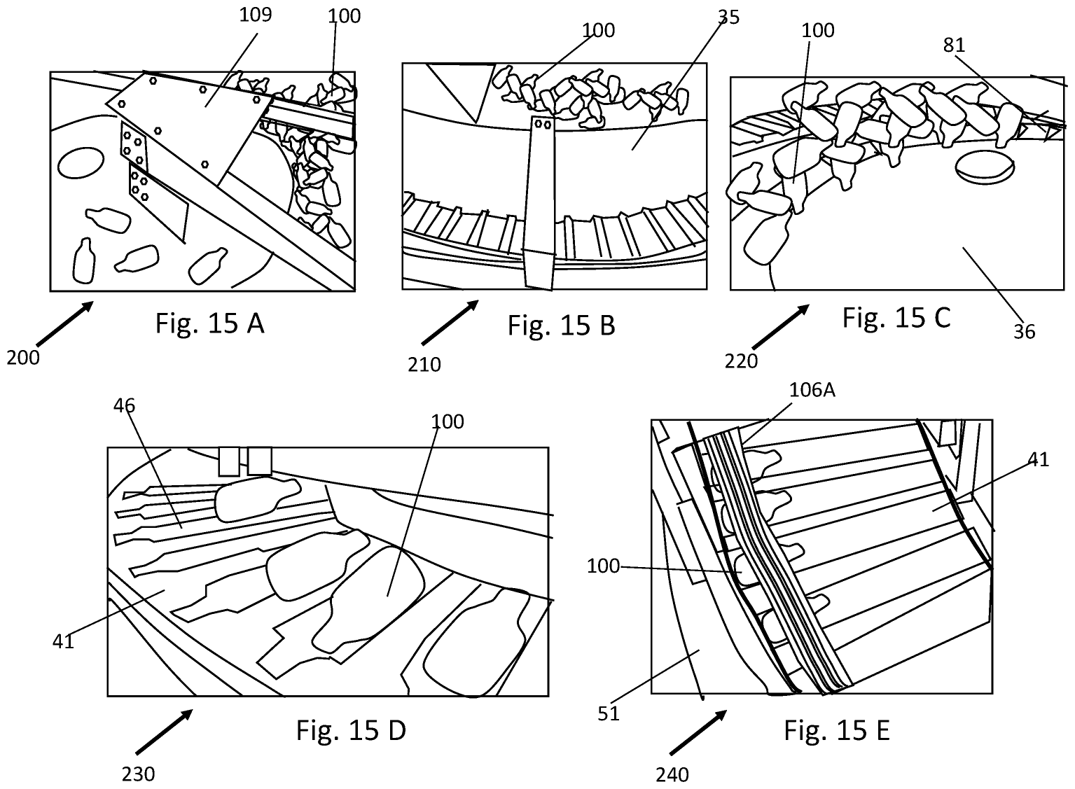

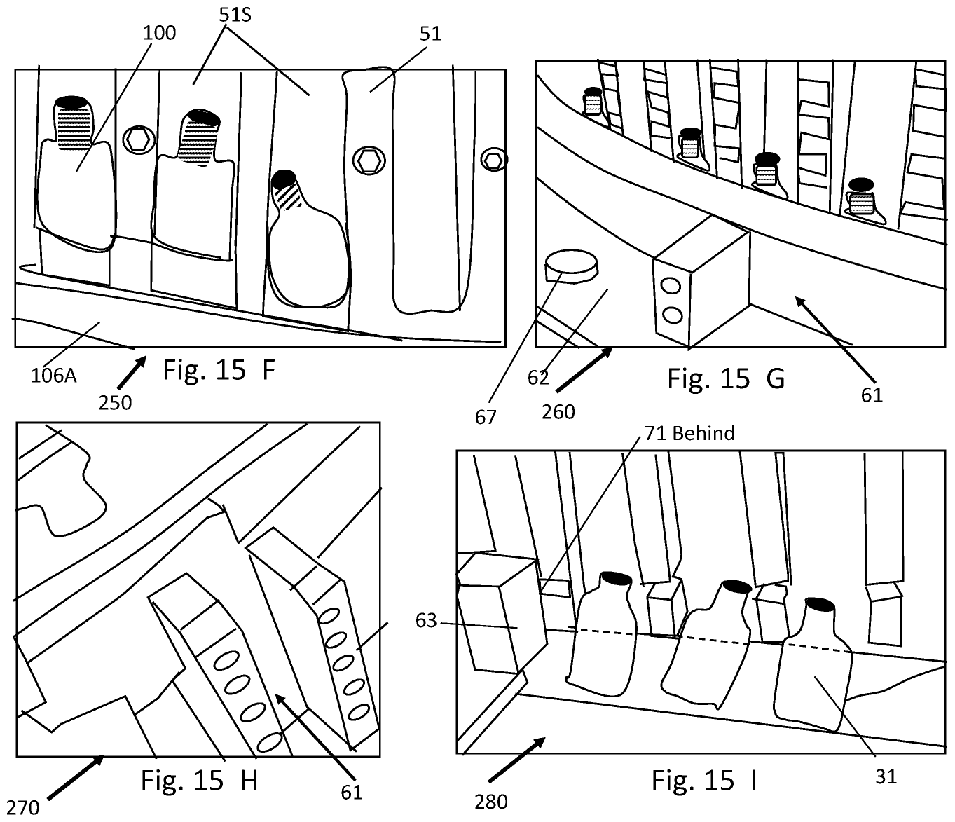

FIGS. 15A through 15I are sketches and photos of the operation of the prototype Scallop Feeder Bowl and Delivery System for Necked Bottles and like objects with features and components noted.

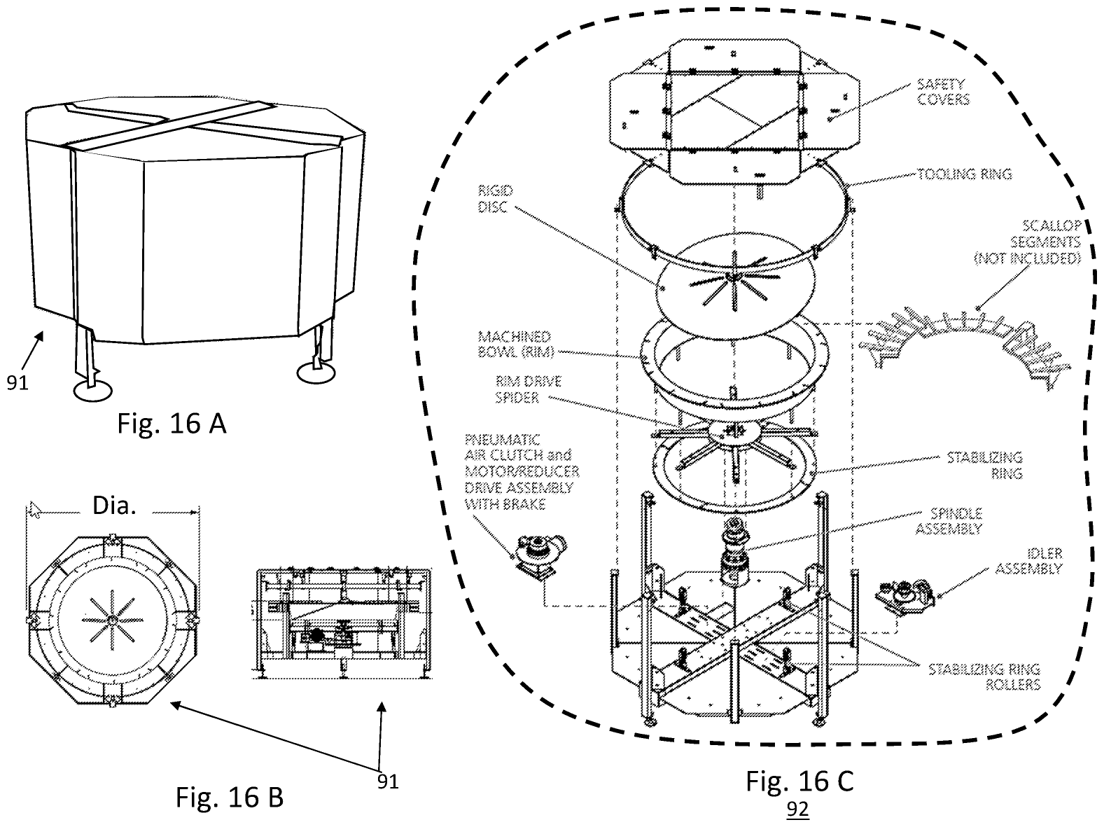

FIGS. 16A through 16C are sketches of the purchased base centrifugal bowl feeder (Shibuya Hoppmann or equal—for example and not limitation) with features and components noted.

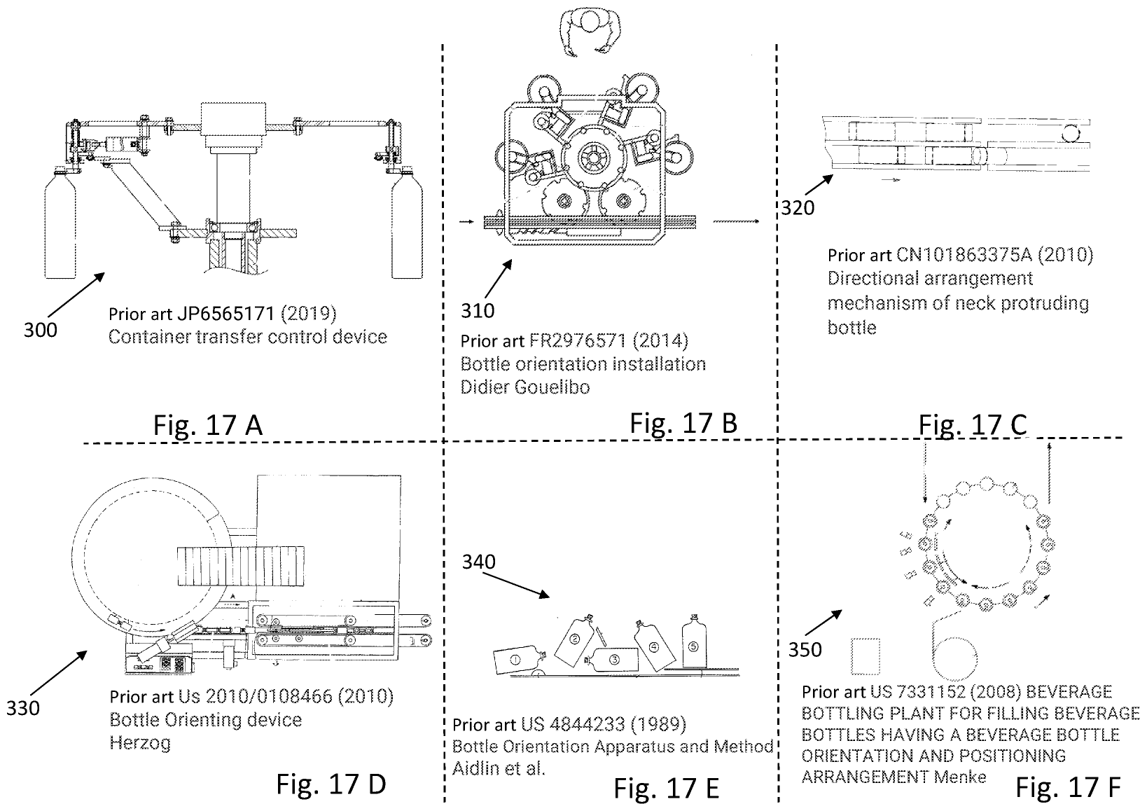

FIGS. 17A through 17F are sketches of prior art for bottle feeders and orientation machines.

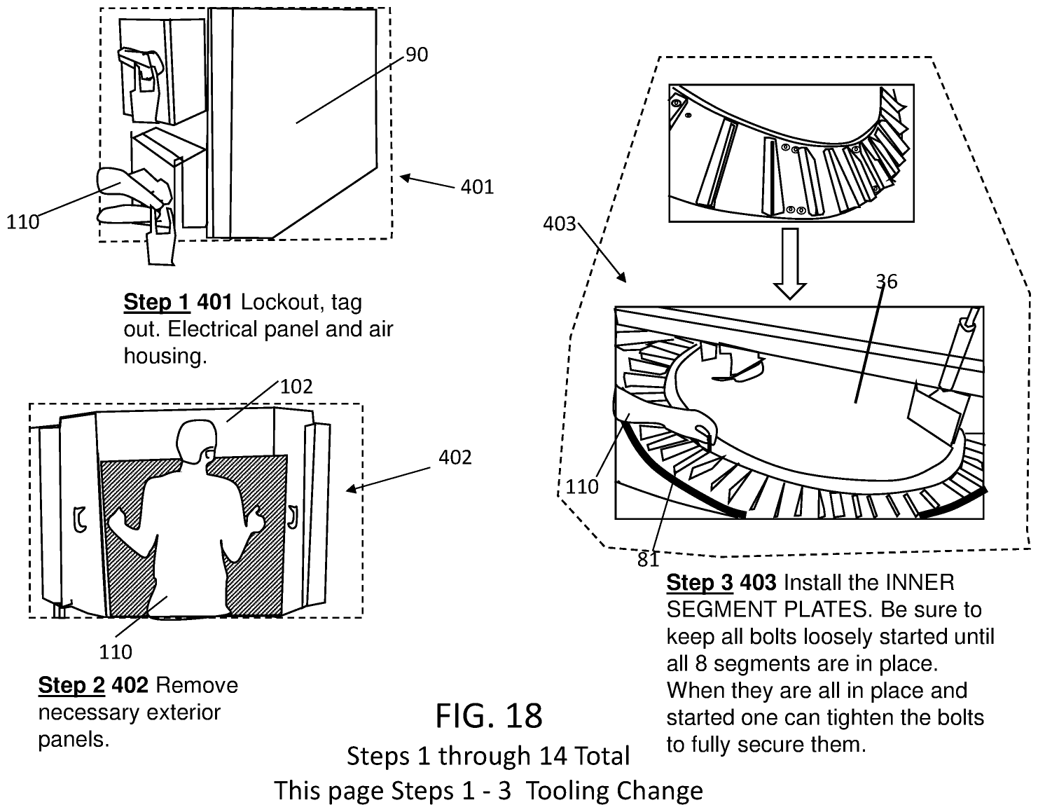

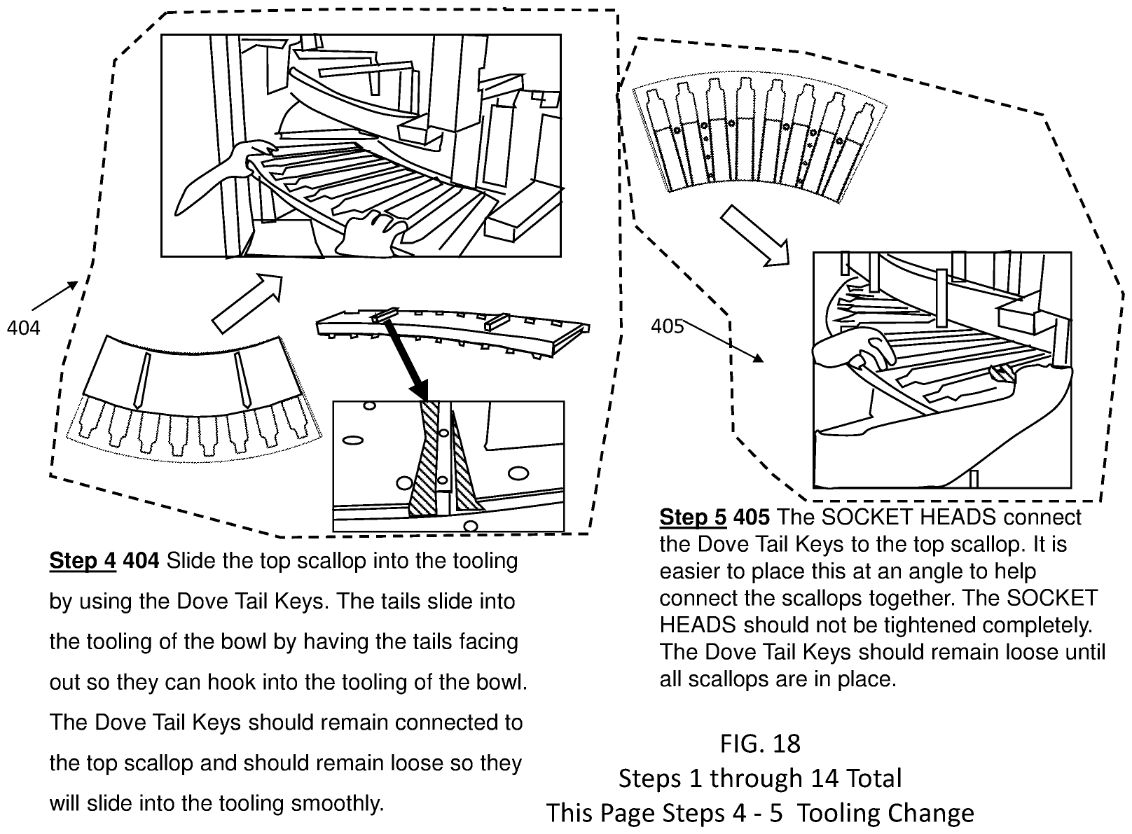

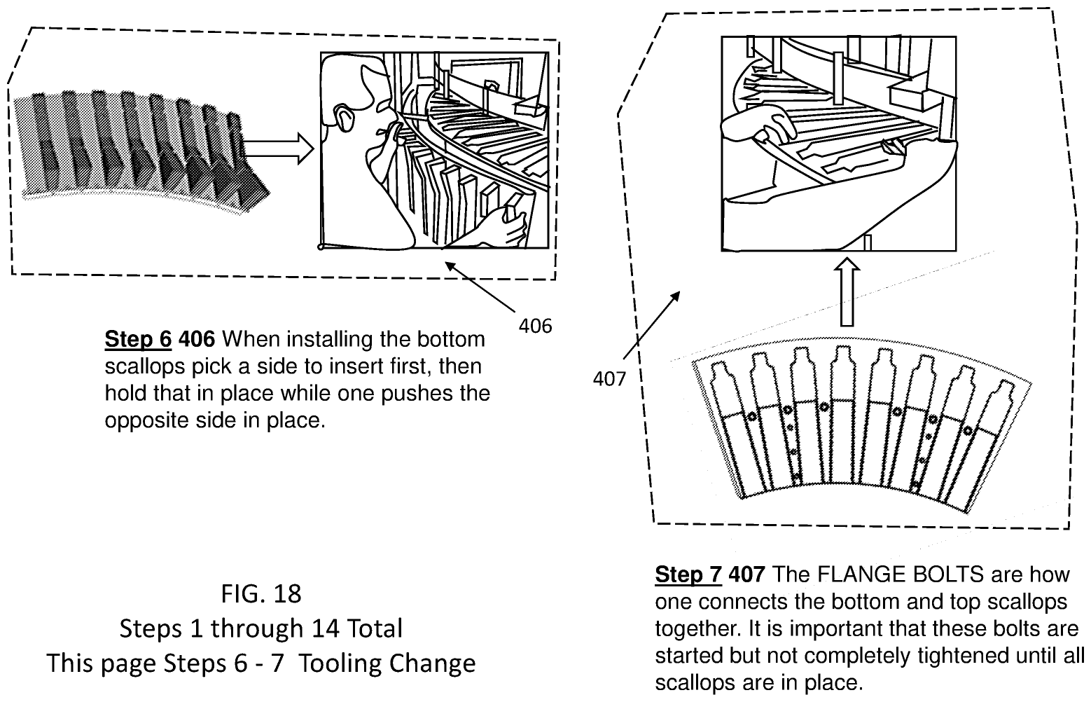

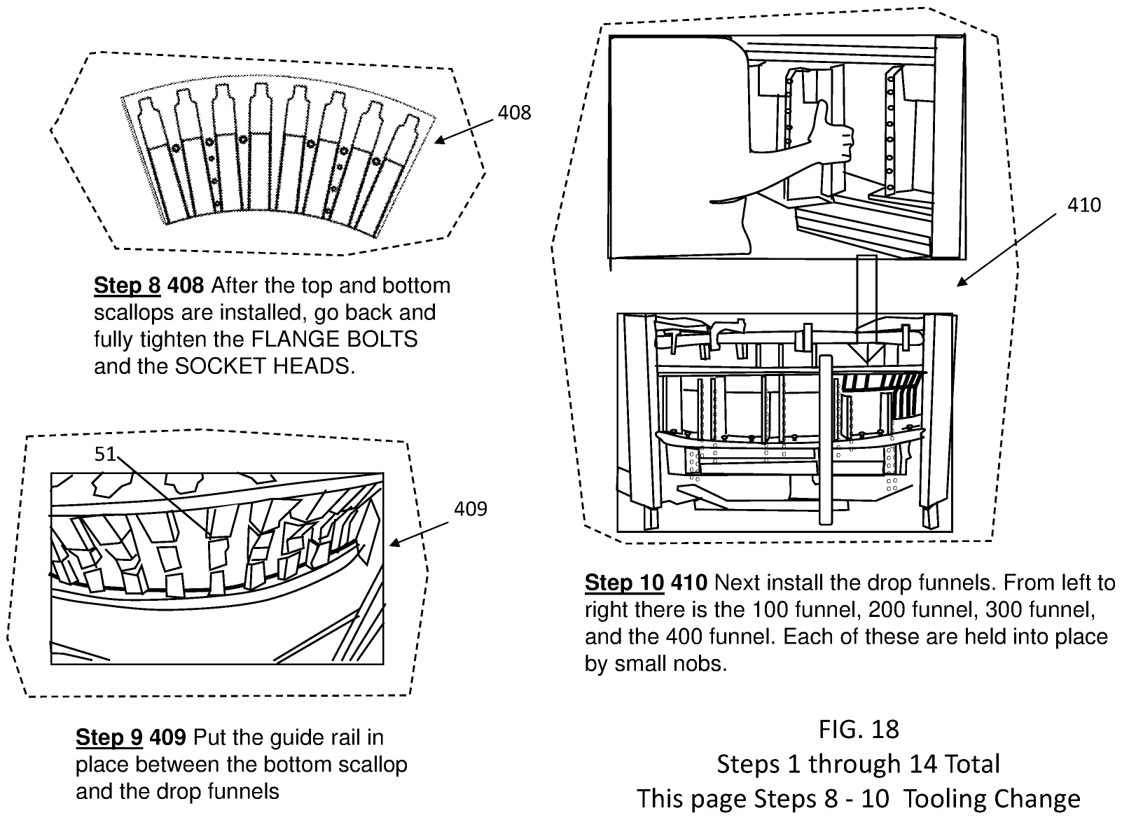

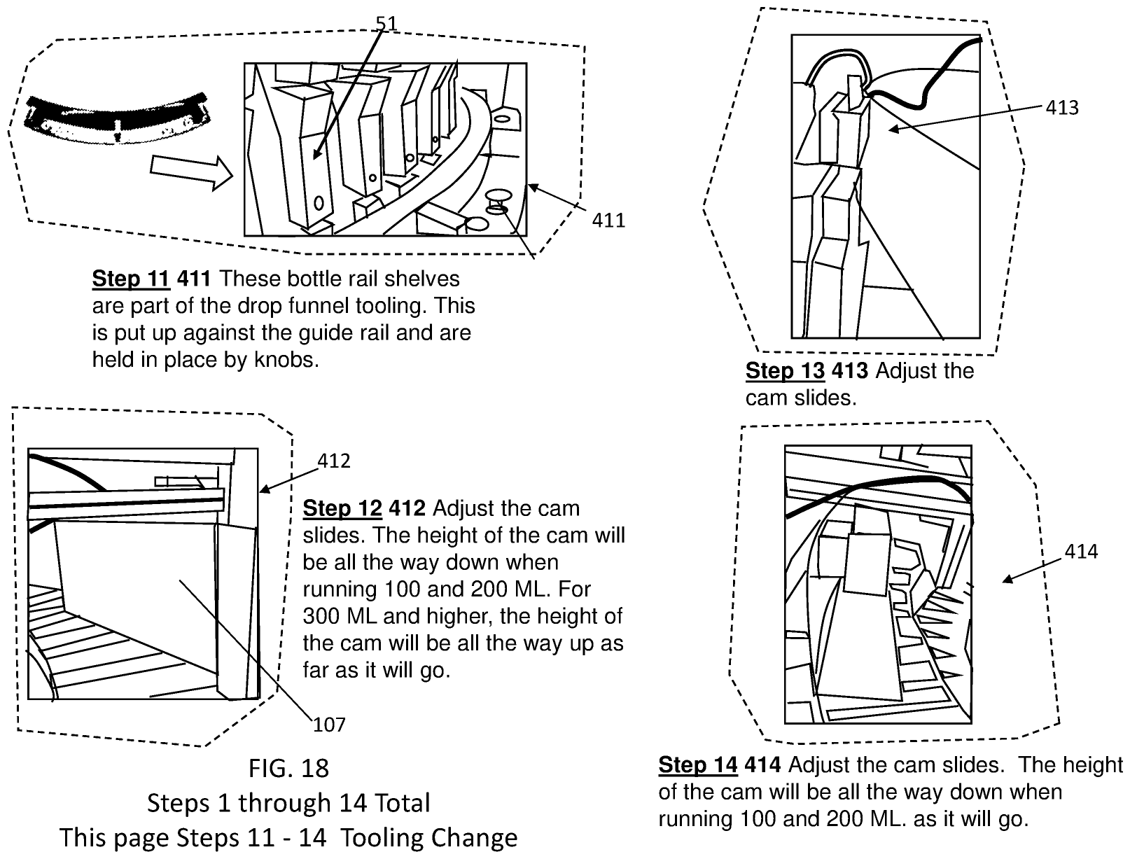

FIG. 18 Steps 1 through Steps 14 are sketches of the tool changeover process for the Scallop Feeder Bowl and Delivery System for Necked Bottles and like objects.

### REFERENCE NUMERALS

The following list refers to the drawings:

Table B: Reference numbers

| Ref # | Description |
|---|---|
| 30 | Scallop feeder bowl and delivery system 30 for |
| | necked bottles 100 and like objects |
| 30A | lower section 30A of Scallop feeder bowl and |
| | delivery system 30 for necked bottles 100 and |
| | like objects |
| 31 | prototype 31 of Scallop feeder bowl and delivery |
| | system 30 for necked bottles 100 and like objects |
| 32 | rear section 32 of prototype scallop feeder 31 |
| 33 | front section 33 of prototype scallop feeder 31 |
| 33A | side section 33A of prototype scallop feeder 31 |
| 33B | rear section 33B of prototype scallop feeder 31 |
| 34 | a structure 34 (tubular or structural shapes) to |
| | support the bowl, drivers and accessories of |
| | Scallop feeder bowl and delivery system 30 for |
| | necked bottles 100 and like objects |
| 34A | adjustable leveling pads/feet of structure 34A |
| 35 | bowl 35 |
| 36 | rigid disk 36 |
| 37 | tooling ring 37 |
| 38 | mounting shelf 38 |
| 38A | top support shelf 38A |
| 39 | oriented parts 105 exit conveyor 39 |
| 40 | upper scallop section 40 |
| 41 | prototype 41 of upper scallop section 40 |
| 41T | top 41T of prototype 41 of upper scallop section |
| | 40 |
| 41B | bottom of 41B of prototype 41 of upper scallop |
| | section 40 |
| 42 | threaded mounting apertures 42 throughout |
| | component parts of Scallop feeder bowl and |
| | delivery system 30 for necked bottles 100 and |
| | like objects |
| 42A | apertures 42A for dovetails 48 through upper |
| | scallop 41 |
| 43 | fasteners 43 such as but not limited to screws, |
| | bolts, pins and like used throughout the |
| | component assembly for Scallop feeder bowl and |
| | delivery system 30 for necked bottles 100 and |
| | like objects |
| 45 | receiving plate 45 for lower 50 and upper 40 |
| | scallops - these are the Upper and Lower scallop |
| | base that receives the interchangeable, unique to |
| | the specific object and bottle size for mounting |
| | the upper and lower scallops |
| 46 | bottle aperture 46 unique for each sized upper |
| | scallop 40 |
| 48 | dovetail male 48 on back of upper scallop 40 |
| 49 | dovetail pocket section 49 on top of receiving |
| | plate 45 |
| 50 | lower scallop section 50 |
| 51 | prototype 51 of lower scallop section 50 |
| 51T | top 51T of prototype 51 of lower scallop section |
| | 50 |
| 51F | front of 51F of prototype 51 of lower scallop |
| | section 50 |
| 51S | space 51S between lower scallop components |
| 55 | guide rail 55 between lower scallop section 50 |
| | and drop funnel section 60 |
| 60 | drop funnel section 60 - with the drop funnel |
| | support which provides the accurate location for |
| | the sections and the unique to the specific |
| | object and bottle size |
| 61 | prototype 61 of drop funnel section 60 |
| 62 | support plate 62 for drop funnel section 60 |
| 63 | bottom rail 63 for drop funnel section 60 |
| 65 | drop funnel track 65 |
| 66 | steel ring inhibitor 66 |
| 67 | hold down knob 67 and threaded bolt of drop |
| | funnel section 60 |
| 70 | extractor tooling 70 to remove oriented bottles |
| | 105 from drop funnel section 60 |
| 71 | prototype 71 of extractor tooling 70 |
| 80 | pre scallop section 80 on shelf 38 |
| 81 | prototype 81 of pre scallop section 80 on shelf |
| | 38 |
| 90 | control and power electrical panels 90 with |
| | electrical power feed and switches for power in |
| | to drive motors of centrifugal feeder 91 |
| 91 | Shibuya Hoppmann or equal centrifugal feeder 91 |
| 92 | features 92 of centrifugal feeder 91 |
| 100 | un-oriented bottle or object 100 |
| 101 | neck or reduced area 101 of bottle 100 |
| 102 | sound panels 102 on structure 34 |
| 103 | sound lid 103 |
| 105 | oriented parts/bottle/object 105 |
| 106 | pneumatic valves 106 for individual control of |
| | director/blow-off air lines |
| 106A | a group of individual control of director/blow- |
| | off air lines 106A |
| 107 | cam slides 107 for height control and selection |
| | of oriented parts 105 |
| 108 | space 108 for bottles 100/105 |
| 109 | feeder conveyors 109 of un-oriented |
| | bottles/objects 100 |
| 110 | user/worker/or tool mechanic 110 |
| 111 | layout diagram 111 of system 30 |
| 200 | bottle 100 entry 200 from feeder conveyors 109 |
| 210 | bottles 100 drop 210 to rigid disk 35 |
| 220 | bottles 100 advance 220 across pre scallops 81 |
| | toward upper scallops 41 |
| 230 | bottles 100 drop 230 into aperture 46 of upper |
| | scallop 41 |
| 240 | bottles 100 drop 240 up righted, oriented 105 |
| | between lower scallops 51 into space 51S |
| 250 | up-righted, oriented bottles 105 continue drop |
| | 250 between lower scallops 51 to ring 63 |
| 260 | oriented bottles 105 advance 260 through drop |
| | funnel 61 |
| 270 | oriented bottles 105 advance 270 through |
| | extractor tooling 71 |
| 280 | oriented bottles 105 advance 280 from scallop |
| | feeder 31 to next machine (wash, fill etc.) |
| 300 | prior art 300 Japanese patent JP6565171 (2019) |
| | named a Container transfer control device |
| 310 | prior art 310 French patent FR2976571 (2014) known |
| | as a Bottle orientation installation issued to |
| | Didier Gouelibo |
| 320 | prior art 320 Chinese publication CN101863375A |
| | (2010) called a Directional arrangement mechanism |
| | of neck protruding bottle |
| 330 | prior art 330 US Publication 2010/0108466 (2010) |
| | titled a Bottle Orienting device and submitted by |
| | Herzog. |
| 340 | prior art 340 U.S. Pat. No. 4,844,233 (1989) named a |
| | Bottle Orientation Apparatus and Method issued to |
| | Aidlin et al. |
| 350 | prior art 350 U.S. Pat. No. 7,331,152 (2008) called a |
| | BEVERAGE BOTTLING PLANT FOR FILLING BEVERAGE |
| | BOTTLES HAVING A BEVERAGE BOTTLE ORIENTATION |
| | AND POSITIONING ARRANGEMENT issued to Menke. |
| 401 | Step 1 401 Lockout, tag out. Electrical panel and |
| | air housing. |
| 402 | Step 2 402 Remove necessary exterior panels. |
| 403 | Step 3 403 Install the INNER SEGMENT PLATES. Be |
| | sure to keep all bolts loosely started until all |
| | 8 segments are in place. When they are all in |
| | place and started one can tighten the bolts to |
| | fully secure them. |
| 404 | Step 4 404 Slide the top scallop into the tooling |
| | by using the Dove Tail Keys. The tails slide into |
| | the tooling of the bowl by having the tails |
| | facing out so they can hook into the tooling of |
| | the bowl. The Dove Tail Keys should remain |
| | connected to the top scallop and should remain |
| | loose so they will slide into the |
| | tooling smoothly. |
| 405 | step 5 405 The SOCKET HEADS connect the Dove Tail |
| | Keys to the top scallop. It is easier to place |
| | this at an angle to help connect the scallops |
| | together. The SOCKET HEADS should not be |
| | tightened completely. The Dove Tail Keys should |
| | remain loose until all scallops are in place. |
| 406 | Step 6 406 When installing the bottom scallops |
| | pick a side to insert first, then hold that in |
| | place while one pushes the opposite side in |
| | place. Here is chosen the right side, lifted into |
| | place, and pushed back. As this is held, one |
| | lifts the left side and pushed that in. During |
| | the tear down process this will need to be taken |
| | off BEFORE the top scallop otherwise it will |
| | fall. |
| 407 | Step 7 407 The FLANGE BOLTS are how one connects |
| | the bottom and top scallops together. It is |
| | important that these bolts are started but not |
| | completely tightened until all scallops are in |
| | place. These FLANGE BOLTS should drop into place |
| | if the top and bottom scallops are in the correct |
| | spot. Sometimes they need one tap to make them |
| | fall into place and then one can get them |
| | started. |
| 408 | Step 8 408 After the top and bottom scallops are |
| | installed, go back and fully tighten the FLANGE |
| | BOLTS (Pink) and the SOCKET HEADS (Yellow). Make |
| | sure to tighten the flange bolt first, then the |
| | socket heads. One should tighten everything once |
| | the top and bottom scallops are in place to help |
| | make the assembly process easier. |
| 409 | Step 9 409 Put the guide rail in place between |
| | the bottom scallop and the drop funnels. |
| 410 | Step 10 410 Next install the drop funnels. From |
| | left to right there is the 100 funnel, 200 |
| | funnel, 300 funnel, and the 400 funnel. Each of |
| | these are held into place by small nobs. Take 200 |
| | funnel out first when taking the tooling off. One |
| | cannot get the 100 funnel out without taking the |
| | 200 funnel out first. When putting the tooling |
| | on, one should put the funnels on in numerical |
| | order. |
| 411 | Step 11 411 These bottle rail shelves are part of |
| | the drop funnel tooling. This is put up against |
| | the guide rail and are held in place by knobs. |
| 412 | Step 12 412 Adjust the cam slides. The height of |
| | the cam will be all the way down when running 100 |
| | and 200 ML. For 300 ML and higher, the height of |
| | the cam will be all the way up as far as it will |
| | go. |
| 413 | Step 13 413 Adjust the cam slides. The height of |
| | the cam will be all the way down when running 100 |
| | and 200 ML. For 300 ML and higher, the height of |
| | the cam will be all the way up as far as it will |
| | go. |
| 414 | Step 14 414 Adjust the cam slides. The height of |
| | the cam will be all the way down when running 100 |
| | and 200 ML. For 300 ML and higher, the height of |
| | the cam will be all the way up as far as it will |
| | go. |

### DETAILED DESCRIPTION OF PREFERRED EMBODIMENT

This invention relates particularly to a Scallop feeder bowl and delivery system 30 for necked bottles 100 and like objects. This invention relates to a container feeder device and system. The present disclosure relates generally to the preparation, orientation and handling various sized bottles and object with one base machine. It also relates to an apparatus or system that incorporates a system that automates the process. The present invention relates to a clean product aligning device made of food grade and cleanable grade materials that are easily disassembled and able to be washed in hot water and steam. It relates to a system that is a singulating system that significantly reduces time, labor, spare parts, capital investment, and waste while increasing productivity, quality, and machine uptime.

This invention is a Scallop feeder bowl and delivery system 30 for a group of un-oriented, necked bottles 100 and like objects that reduces changeover time (product tooling changeover), labor, initial capital investments, floor space requirements, and waste while increasing overall machine uptime/usage, productivity, quality (repeatability), spare parts inventory, and maintenance (training and understanding of equipment). The main function of this design is to build a machine with completely interchangeable pieces for multiple parts handling.
C. Interchangeable upper parts
   1. Upper Scallop
   2. Pre-scallop section has interchangeable sections allow for multiple parts with easy changeover
D. Interchangeable lower and supporting parts
   1. Lower Scallop
   2. Custom drop funnel sections
   3. Extractor tooling sections
   4. Steel ring inhibitor

The preferred embodiment of a Scallop feeder bowl and delivery system 30 for necked bottles 100 and like objects, the system 30 is comprised of: a) a set of interchangeable upper parts including—a set of Upper Scallops which have interchangeable sections and a set of Pre-scallop section which have interchangeable sections that allow for multiple parts unique to each bottle/object size;
b) a set of interchangeable lower and supporting parts including—a set of Lower Scallops which have interchangeable parts, a set of custom drop funnel sections, a set of Extractor tooling sections, and a Steel ring inhibitor wherein the system is built with completely interchangeable pieces for multiple parts handling, the system results in reduced changeover time (product tooling changeover), labor, initial capital investments, floor space requirements, spare parts inventory, maintenance (training and understanding of equipment), and waste, and the system increased overall machine uptime/usage, productivity, quality (repeatability).

And an alternative embodiment is a Scallop feeder bowl and delivery system 30 for a group of un-oriented, necked bottles 100 and like objects, the process used in the system 30 is comprised of: Step 200: bottle 100 entry 200 from feeder conveyors 109;
Step 210: bottles 100 drop 210 to rigid disk 35;
Step 220: bottles 100 advance 220 across pre scallops 81 toward upper scallops 41;
Step 230: bottles 100 drop 230 into aperture 46 of upper scallop 41;
Step 240: bottles 100 drop 240 up righted. oriented 105 between lower scallops 51 into space 51S;
Step 250: up-righted, oriented bottles 105 continue drop 250 between lower scallops 51 to ring 63;
Step 260: oriented bottles 105 advance 260 through drop funnel 61;
Step 270: oriented bottles 105 advance 270 through extractor tooling 71; and
Step 280: oriented bottles 105 advance 280 from scallop feeder 31 to next machine (wash, fill etc.)
   wherein the system is built with completely interchangeable pieces for multiple parts handling, the system results in reduced changeover time (product tooling changeover), labor, initial capital investments, floor space requirements, spare parts inventory, maintenance (training and understanding of equipment), and waste, and the system increased overall machine uptime/usage, productivity, quality (repeatability).

There is shown in FIGS. 1-18 a complete description and operative embodiment of the Scallop feeder bowl and delivery system 30 for necked bottles 100 and like objects. In the drawings and illustrations, one notes well that the FIGS. 1-18 demonstrate the general configuration and use of this product. The various example uses are in the operation and use section, below.

The accompanying drawings, which are incorporated in and constitute a part of this specification, illustrate an embodiment of the Scallop feeder bowl and delivery system 30 for necked bottles 100 and like that is preferred. The drawings together with the summary description given above and a detailed description given below serve to explain the principles of the Scallop feeder bowl and delivery system 30. It is understood, however, that the device and system 30 is not limited to only the precise arrangements and instrumentalities shown. Other examples of bottle and object orienting machines and systems for versatile use with many sized bottles are still understood by one skilled in the art of feeding equipment and devices to be within the scope and spirit shown here.

FIGS. 1A through 1C are sketches of the general Scallop Feeder Bowl and Delivery System 30 for Necked Bottles and like objects 100 plus sketches of an upper scallop section 40 and a lower scallop section 50. Next in FIGS. 2A and 2B are front and back views of the Scallop Feeder Bowl and Delivery System 30 for Necked Bottles and like objects with components and features noted. Shown in these sketches are: a prototype 31 of Scallop feeder bowl and delivery system 30 for necked bottles 100 and like objects; a rear section 32 of prototype scallop feeder 31; a front section 33 of prototype scallop feeder 31; a structure 34 (tubular or structural shapes) to support the bowl, drivers and accessories of Scallop feeder bowl and delivery system 30 for necked bottles 100 and like objects; a adjustable leveling pads/feet of structure 34A; a bowl 35; a rigid disk 36; a tooling ring 37; an oriented parts 105 exit conveyor 39; an upper scallop section 40 (removable for specific products); a lower scallop section 50 (removable for specific products); a drop funnel section 60 (removable for specific products); and an extractor tooling 70 (removable for specific products) to remove oriented bottles 105 from drop funnel section 60.

FIGS. 3A through 3C are sketches of the Top, front and side views of the Scallop Feeder Bowl and Delivery System for Necked Bottles and like objects with components and features noted. These drawings provide the following components: a Scallop feeder bowl and delivery system 30 for necked bottles 100 and like objects; a front section 33 of scallop feeder 30; a side section 33A of scallop feeder 30; a structure 34 (tubular or structural shapes) to support the bowl, drivers and accessories of Scallop feeder bowl and delivery system 30 for necked bottles 100 and like objects; an adjustable leveling pads/feet of structure 34A; a bowl 35; a rigid disk 36; a tooling ring 37; a mounting shelf 38; an oriented parts 105 exit conveyor 39; an upper scallop section 40 (removable for specific products); a bottle aperture 46 unique for each sized upper scallop 40; a lower scallop section 50 (removable for specific products); and a drop funnel section 60 (removable for specific products).

FIGS. 4A through 4C are sketches of the lower sections 30A isometric, top and side views of the Scallop Feeder Bowl and Delivery System 30 for Necked Bottles and like objects with components and features noted. Demonstrated in these views are: a lower section 30A of Scallop feeder bowl and delivery system 30 for necked bottles 100 and like objects; a structure 34 (tubular or structural shapes) to support the bowl, drivers and accessories of Scallop feeder bowl and delivery system 30 for necked bottles 100 and like objects; a set of adjustable leveling pads/feet of structure 34A; a bowl 35; a rigid disk 36; a tooling ring 37; a mounting shelf 38; a top support shelf 38A; an oriented parts 105 exit conveyor 39; and a set of threaded mounting apertures 42 throughout component parts of Scallop feeder bowl and delivery system 30 for necked bottles 100 and like objects.

FIGS. 5A through D are sketches and photos of the prototype 31 Scallop Feeder Bowl and Delivery System for Necked Bottles and like objects with components and features noted. Provided here are: a prototype 31 of Scallop feeder bowl and delivery system 30 for necked bottles 100 and like objects; a structure 34 (tubular or structural shapes) to support the bowl, drivers and accessories of Scallop feeder bowl and delivery system 30 for necked bottles 100 and like objects; a prototype 41 of upper scallop section 40; a prototype 51 of lower scallop section 50; a prototype 61 of drop funnel section 60—with the drop funnel support which provides the accurate location for the sections and the unique to the specific object and bottle size; a control and power electrical panels 90 with electrical power feed and switches for power in to drive motors of centrifugal feeder 91; a set of sound panels 102 on structure 34; a sound lid 103; and a user/worker/or tool mechanic 110.

FIGS. 6A through 6C are sketches of Pre scallop sections 80 of the Scallop Feeder Bowl and Delivery System 30 where the bottles and objects first enter the bowl from an un-oriented conveyor 109. These views show: a rigid disk 36; a top support shelf 38A; a prototype 41 of upper scallop section 40; a receiving plate 45 for lower 50 and upper 40 scallops—these are the Upper and Lower scallop base that receives the interchangeable, unique to the specific object and bottle size for mounting the upper and lower scallops; a prototype 81 of pre scallop section 80 on shelf 38; and a user/worker/or tool mechanic 110. Remember for the pre scallop sections, they are completely interchangeable, so the machine is capable of handling multiple parts, they bolt into place; and one changes the number and spacing of the pre scallop sections with the different sized bottles.

FIGS. 7A through 7F are sketches of the upper scallops 40 with features and components noted. Here in these sketches are shown and portrayed: an upper scallop section 40; a prototype 41 of upper scallop section 40; a top 41T of prototype 41 of upper scallop section 40; a bottom of 41B of prototype 41 of upper scallop section 40; a threaded mounting apertures 42 throughout component parts of Scallop feeder bowl and delivery system 30 for necked bottles 100 and like objects; a series of apertures 42A for dovetails 48 through upper scallop 41; a set of fasteners 43 such as but not limited to screws, bolts, pins and like used throughout the component assembly for Scallop feeder bowl and delivery system 30 for necked bottles 100 and like objects; a receiving plate 45 for lower 50 and upper 40 scallops—these are the Upper and Lower scallop base that receives the interchangeable, unique to the specific object and bottle size for mounting the upper and lower scallops; a bottle aperture 46 unique for each sized upper scallop 40; a dovetail male 48 on back of upper scallop 40; and a dovetail pocket section 49 on top of receiving plate 45. For the upper scallops 40, remember that these 40 are completely interchangeable so that the machine is capable of handling multiple parts, there is a dove-tail mechanical holding design for easy assembly and deconstruction, one cannot lift out the upper scallop 40, rather it must slide in and out of position, once positioned the upper scallop 40 bolts into place, and one must invert (on bottom 41B) of upper scallops and slides into unchanging base 45 underneath dovetail design 49.

FIGS. 8A through 8F are sketches and photos of the prototype upper scallops 41 with features and components noted. Indicated here are: a prototype 41 of upper scallop section 40; a top 41T of prototype 41 of upper scallop section 40; a threaded mounting apertures 42 throughout component parts of Scallop feeder bowl and delivery system 30 for necked bottles 100 and like objects; a series of apertures 42A for dovetails 48 through upper scallop 41; a set of fasteners 43 such as but not limited to screws, bolts, pins and like used throughout the component assembly for Scallop feeder bowl and delivery system 30 for necked bottles 100 and like objects; a receiving plate 45 for lower 50 and upper 40 scallops—these are the Upper and Lower scallop base that receives the interchangeable, unique to the specific object and bottle size for mounting the upper and lower scallops; a bottle aperture 46 unique for each sized upper scallop 40; and an user/worker/or tool mechanic 110.

FIGS. 9A through 9C are sketches of the lower scallops 50 with features and components noted. Demonstrated are: an upper scallop section 40; a threaded mounting apertures 42 throughout component parts of Scallop feeder bowl and delivery system 30 for necked bottles 100 and like objects; a set of fasteners 43 such as but not limited to screws, bolts, pins and like used throughout the component assembly for Scallop feeder bowl and delivery system 30 for necked bottles 100 and like objects; a lower scallop section 50; top 50T of lower scallop section 50; a front of 51F of lower scallop section 50; and a space 51S between lower scallop components. Remember that these 50 are completely interchangeable so that the machine is capable of handling multiple parts and the lower scallop 50 bolts into place.

FIGS. 10A through 10 F are sketches and photos of the prototype lower scallops with features and components noted. Shown in the prototype views are a mounting shelf 38; a prototype 41 of upper scallop section 40; a bottle aperture 46 unique for each sized upper scallop 40; a prototype 51 of lower scallop section 50; a space 51S between lower scallop components; a guide rail 55 between lower scallop section 50 and drop funnel section 60; and a user/worker/or tool mechanic 110.

FIGS. 11A through 11C are sketches of the Drop Funnel Segments 60 and Extractor Tooling 70 with features and components noted. Shown are a drop funnel section 60—with the drop funnel support which provides the accurate location for the sections and the unique to the specific object and bottle size; a steel ring inhibitor 66; and an extractor tooling 70 to remove oriented bottles 105 from drop funnel section 60. For the Drop Funnel Segments 60 and Extractor Tooling 70, one should remember—they are completely interchangeable so the machine is capable of handling multiple parts, the steel ring inhibitor 66 at the bottom of the feeder limits position of drop funnel 60 and extractor 70 for easier changeover, there are sectional pin hole spacings so only corresponding parts can be locked into position, and the sections screw into place with knobs 67.

FIGS. 12A through 12G are sketches and photos of the prototype Drop Funnel Segments 61 and Extractor Tooling 71 with features and components noted. Portrayed components and features are: a prototype 31 of Scallop feeder bowl and delivery system 30 for necked bottles 100 and like objects; a structure 34 (tubular or structural shapes) to support the bowl, drivers and accessories of Scallop feeder bowl and delivery system 30 for necked bottles 100 and like objects; a mounting shelf 38; a prototype 51 of lower scallop section 50; a guide rail 55 between lower scallop section 50 and drop funnel section 60; a prototype 61 of drop funnel section 60—with the drop funnel support which provides the accurate location for the sections and the unique to the specific object and bottle size; a support plate 62 for drop funnel section 60; a hold down knob 67 and threaded bolt of drop funnel section 60; a prototype 71 of extractor tooling 70; and an user/worker/or tool mechanic 110.

FIGS. 13A through 13F are sketches and photos of the prototype qualifiers as cam slides 106 to divert and select properly oriented bottles and objects with features and components noted. In these views are displayed: a prototype 41 of upper scallop section 40; a group of pneumatic valves 106 for individual control of director/blow-off air lines 106A; a group of individual control of director/blow-off air lines 106A; a cam slides 107 for height control and selection of oriented parts 105; a space 108 for bottles 100/105; and a user/worker/or tool mechanic 110.

FIG. 14 is a sketch of a layout 111 of the feeder conveyors and system to the Scallop Feeder Bowl and Delivery System 30 for Necked Bottles and like objects with features and components noted. This overview shows: a Scallop feeder bowl and delivery system 30 for necked bottles 100 and like objects; an oriented parts 105 exit conveyor 39; a pre scallop feeder conveyor 109 of un-oriented bottles/objects 100; a user/worker/or tool mechanic 110; and a layout diagram 111 of system 30. The various feed conveyors are, for example and not as a limitation to the system, PREFEEDER CONVEYOR 48″ W×14′ LG SMOOTH BELT SPEED=10 FPM; INCLINE CONVEYOR 36″ W×14′ LG 6″ CLEATS STAINLESS SIDE WALLS SPEED=50 FPM; FEED CONVEYOR 32″ W×13′ LG SMOOTH BELT STAINLESS SIDE WALLS SPEED=15 FPM; BOWL CONVEYOR 16″ W×31′ LG SMOOTH BELT STAINLESS SIDE WALLS SPEED=30 FPM; BOWL CONVEYOR 16″ W×18′ LG SMOOTH BELT STAINLESS SIDE WALLS SPEED=30 FPM. In addition is a GAYLORD DUMPER SPLIT SAZERAC HOPPER.

FIGS. 15A through 15I are sketches and photos of the operation of the prototype Scallop Feeder Bowl and Delivery System 30 for Necked Bottles and like objects with features and components noted. This is described below in the Operation Section.

FIGS. 16A through 16C are sketches of the purchased base centrifugal bowl feeder 91 (Shibuya Hoppmann or equal—for example and not limitation) with features and components noted. Demonstrated are a Shibuya Hoppmann or equal centrifugal feeder 91 and a group of features 92 of centrifugal feeder 91.

FIGS. 17A through 17F are sketches of prior art for bottle feeders and orientation machines. The Prior Art includes: prior art 300 Japanese patent JP6565171 (2019) named a Container transfer control device; prior art 310 French patent FR2976571 (2014)known as a Bottle orientation installation issued to Didier Gouelibo; prior art 320 Chinese publication CN101863375A (2010) called a Directional arrangement mechanism of neck protruding bottle; prior art 330 U.S. Publication 2010/0108466 (2010) titled a Bottle Orienting device and submitted by Herzog; prior art 340 U.S. Pat. No. 4,844,233 (1989) named a Bottle Orientation Apparatus and Method issued to Aidlin et al.; and prior art 350 U.S. Pat. No. 7,331,152 (2008) called a BEVERAGE BOTTLING PLANT FOR FILLING BEVERAGE BOTTLES HAVING A BEVERAGE BOTTLE ORIENTATION AND POSITIONING ARRANGEMENT issued to Menke. As can be seen, the novel scallop feeder bowl and delivery system 30 for necked bottles 100 and like as compared to prior art is a unique combination and use as described herein.

FIG. 18 Steps 1 through Steps 14 are sketches of the tool changeover process for the Scallop Feeder Bowl and Delivery System for Necked Bottles and like objects. This is described below in the Operation Section.

The anticipated materials for the Scallop feeder bowl and delivery system 30 for necked bottles 100 and like include: for the part contact surfaces—an Acrylonitrile Butadiene Styrene (ABS) Plastic Disc, high temperature Delrin RTM plastic, a 304 Stainless Steel Tooling ring, a FDA approved Acetal (Polyoxymethylene, POM) belt material or equal for each conveyor, a 304 Stainless Steel Reorientation Cam, a 304 Stainless Steel Height Qualifier, Frame Construction—a 304 Stainless Steel Tubing with wash features for cleanability. All are washable with hot water and commercial/industrial soaps for preparation, and all can resist extreme hot water and steam sprays for quasi sterilization. Sizes and construction details anticipated are wash down motor/gearbox w/ common part numbers; all bearings to be sealed and greasable with Zerk fittings and pointing outwardly for access; and a drive pulley to be of a griptwist material or equal. Others include some Polyvinyl Chloride (PVC), Polyethylene terephthalate (PETE or PET), and high temperature Polypropylene (PP) compounds. As durable and composite materials are developed, it is anticipated they can replace some of the Stainless-Steel components.

The details mentioned here are exemplary and not limiting. Other specific components and manners specific to describing a Scallop feeder bowl and delivery system 30 for necked bottles 100 and like can be added as a person having ordinary skill in the field of the art of feeding systems and equipment and their uses well appreciates.

### OPERATION OF THE PREFERRED EMBODIMENT

The Scallop feeder bowl and delivery system 30 for necked bottles 100 and like has been described in the above embodiment. The manner of how the device operates is described below. One notes well that the description above and the operation described here must be taken together to fully illustrate the concept of the new scallop feeder bowl and delivery system 30.

The preferred embodiment of a Scallop feeder bowl and delivery system 30 for a group of un-oriented, necked bottles 100 and like objects, the system 30 is comprised of:
a) a set of interchangeable upper parts including—a set of Upper Scallops which have interchangeable sections and a set of Pre-scallop section which have interchangeable sections that allow for multiple parts unique to each bottle/object size;
b) a set of interchangeable lower and supporting parts including—a set of Lower Scallops which have interchangeable parts, a set of custom drop funnel sections, a set of Extractor tooling sections, and a Steel ring inhibitor wherein the system is built with completely interchangeable pieces for multiple parts handling, the system results in reduced changeover time (product tooling changeover), labor, initial capital investments, floor space requirements, spare parts inventory, maintenance (training and understanding of equipment), and waste, and the system increased overall machine uptime/usage, productivity, quality (repeatability).

And an alternative embodiment is a Scallop feeder bowl and delivery system 30 for a group of un-oriented, necked bottles 100 and like objects, the process used in the system 30 is comprised of: Step 200: bottle 100 entry 200 from feeder conveyors 109;
Step 210: bottles 100 drop 210 to rigid disk 35;
Step 220: bottles 100 advance 220 across pre scallops 81 toward upper scallops 41;
Step 230: bottles 100 drop 230 into aperture 46 of upper scallop 41;
Step 240: bottles 100 drop 240 up righted, oriented 105 between lower scallops 51 into space 51S;
Step 250: up-righted, oriented bottles 105 continue drop 250 between lower scallops 51 to ring 63;
Step 260: oriented bottles 105 advance 260 through drop funnel 61;
Step 270: oriented bottles 105 advance 270 through extractor tooling 71; and
Step 280: oriented bottles 105 advance 280 from scallop feeder 31 to next machine (wash, fill etc.)
   wherein the system is built with completely interchangeable pieces for multiple parts handling, the system results in reduced changeover time (product tooling changeover), labor, initial capital investments, floor space requirements, spare parts inventory, maintenance (training and understanding of equipment), and waste, and the system increased overall machine uptime/usage, productivity, quality (repeatability).

An overview of theory of operation for the Scallop feeder bowl and delivery system 30 for necked bottles 100 and like is generally as follows:

### Theory of Operation

1. Parts are dropped onto the disc and centrifugal momentum pushes the parts away from center toward the pre-scallop section;
2. The pre-scallop sections help to assist part orientation, so the part is properly loaded into the upper scallop;
3. The part is orientated one of two ways either facing in toward the center of the machine or facing out away from the center of the machine within the upper scallop;
4. The part travels until reaching the drop funnel segment
5. Parts facing out away from center will drop first and be funneled into position on the lower scallop;
6. Parts facing in towards the center will drop later in the tooling and be funneled into position on the lower scallop
   These parts will get a slight push back towards center to ensure clean drop
7. The lower scallops will continue to push parts along the bottom plate of the feeder until it reaches the extractor tooling; and
8. The extractor tooling separates the part from the lower scallop and assists in pushing the part toward the discharge and/or conveyor.

The feeder bowl continues to feed bottles to the upper and lower scallop segments. Parts enter the system through the chute located on top of the lid 103. The bowl level sensor turns the pre-feeder on/off as necessary to keep the correct part level in the feeder to increase efficiency and maximize output rate. Then the begins the next important steps of controlling and orienting the bottles 100. (See FIGS. 13A through 13F). The operation of the Scallop Feeder Bowl and Delivery System 30 has the controlling tools (cam slides 107) and pneumatics. The pneumatics are control valves 106 and group of individual control of director/blow-off air lines 106A. The valves 106 are timed and controlled in the control panel 90 to release air to the airlines 106A. These regulator valves 106 tell how much force to use on the bowl. The more air, the more force. The less air, the less force. This tooling protects the air jets lining the outside of the bowl by ensuring the parts cannot be taken beyond this point in this area of the machine. The airlines may be placed in various arrays. For example:
A. Air Jets #1 are both height qualifiers. They blow off extra layers of parts to reduce it to one.
B. Air Jet #2 and #3 are both load assists. Air Jet #2 loads the parts onto the running surface of the bowl while Air Jet #3 assists in loading the parts from the preload to upper segment.
C. Air Jet #4, Air Jet #5, and Air Jet #6 are all selectors. If a bottle is mis-oriented, it will be blown back into the center to be recirculated.
D. Air Jet #4, Air Jet #5, and Air Jet #6 are all selectors. If a bottle is mis-oriented, it will be blown back into the center to be recirculated.
E. Air Jet #7 is a load assist. It helps load the parts onto the running surface of the bowl.
F. Air Jet #8 and Air Jet #9 are both selectors. If a bottle is mis-oriented, it will be blown back into the center to be recirculated.
G. Air Jets #10 and #11 are both height qualifiers. They blow off extra layers of parts to reduce it to one.
H. Air Jet #12 is a load assist. Air Jet #12 blows parts back into the upper scallop.
I. Air Jet #13 is the high-level diverter and rejects parts back into the center for recirculation when the high-level sensor is blocked on the air conveyor.
J. Air Jet #14 is an adjustable height tooling. This moves based on the sizes of each part and helps prevent parts from being double stacked.
K. Air Jet #14 is an adjustable height tooling. This moves based on the sizes of each part and helps prevent parts from being double stacked.
L. Air Jet #15 helps assist parts into the preload.
M. Air Jet #16 helps preposition parts before the parts can hit the funnel drop.
N. Air Jet #17 is one of two air jets that assists the parts into the drop funnels. Air jet #17 pushes the parts through the scallop so they can continue to be tooled.
O. Air Jet #18 is the second air jet that assists the parts into the drop funnels. Air jet #18 pushes the parts through the scallop so they can continue to be tooled.
   (The actual placements of airlines vary and in some places are considered trade secrets, so drawings of placement are not shared nor is the place location claimed)

As for the cam slides 107 for height control and selection of oriented parts 105, each of these are cam slides. The cam slides allow for each bottle to be tooled through the machine when they are in the correct placement. The height of the cam will be all the way down when running 100 and 200 ML. For 300 ML and higher, the height of the cam will be all the way up as fast as it can go. Parts are blown and dropped into the drop tunnels. No matter what way the part falls into the drop funnel, it will be oriented the correct way for the part's next stage. After the part goes through drop funnels the bottle rail shelves take the part to its next stage.

FIGS. 15A through 15I are sketches and photos of the general operation as described above for the prototype Scallop Feeder Bowl and Delivery System 30. The described views are as follows in Table C:

| | |
|---|---|
| 200 | bottle 100 entry 200 from feeder |
| | conveyors 109 |
| 210 | bottles 100 drop 210 to rigid disk 35 |
| 220 | bottles 100 advance 220 across pre |
| | scallops 81 toward upper scallops 41 |
| 230 | bottles 100 drop 230 into aperture 46 of |
| | upper scallop 41 |
| 240 | bottles 100 drop 240 up righted, |
| | oriented 105 between lower scallops 51 |
| | into space 51S |
| 250 | up-righted, oriented bottles 105 |
| | continue drop 250 between lower scallops |
| | 51 to ring 63 |
| 260 | oriented bottles 105 advance 260 through |
| | drop funnel 61 |
| 270 | oriented bottles 105 advance 270 through |
| | extractor tooling 71 |
| 280 | oriented bottles 105 advance 280 from |
| | scallop feeder 31 to next machine (wash, |
| | fill etc.) |

FIG. 18 with Steps 1 through Steps 14 are sketches of the tool changeover process for the Scallop Feeder Bowl and Delivery System for Necked Bottles and like objects. The tool changeover process is shown in FIG. 18 and is described as follows in Table D:

| Step label | |
|---|---|
| in FIG. 18 | Tooling Changeover Activity |
| 401 | Step 1 401 Lockout, tag out. Electrical |
| | panel and air housing. |
| 402 | Step 2 402 Remove necessary exterior panels. |
| 403 | Step 3 403 Install the INNER SEGMENT PLATES. |
| | Be sure to keep all bolts loosely started |
| | until all 8 segments are in place. When they |
| | are all in place and started one can tighten |
| | the bolts to fully secure them. |
| 404 | Step 4 404 Slide the top scallop into the |
| | tooling by using the Dove Tail Keys. The |
| | tails slide into the tooling of the bowl by |
| | having the tails facing out so they can hook |
| | into the tooling of the bowl. The Dove Tail |
| | Keys should remain connected to the top |
| | scallop and should remain loose so they will |
| | slide into the tooling smoothly. |
| 405 | step 5 405 The SOCKET HEADS connect the Dove |
| | Tail Keys to the top scallop. It is easier |
| | to place this at an angle to help connect |
| | the scallops together. The SOCKET HEADS |
| | should not be tightened completely. The Dove |
| | Tail Keys should remain loose until all |
| | scallops are in place. |
| 406 | Step 6 406 When installing the bottom |
| | scallops pick a side to insert first, then |
| | hold that in place while one pushes the |
| | opposite side in place. Here is chosen the |
| | right side, lifted into place, and pushed |
| | back. As this is held, lift the left side, |
| | and pushed that in. During the tear down |
| | process this will need to be taken off |
| | BEFORE the top scallop otherwise it will |
| | fall. |
| 407 | step 7 407 The FLANGE BOLTS are how one |
| | connects the bottom and top scallops |
| | together. It is important that these bolts |
| | are started but not completely tightened |
| | until all scallops are in place. These |
| | FLANGE BOLTS should drop into place if the |
| | top and bottom scallops are in the correct |
| | spot. Sometimes they need one tap to make |
| | them fall into place and then one can get |
| | them started. |
| 408 | Step 8 408 After the top and bottom scallops |
| | are installed, go back and fully tighten the |
| | FLANGE BOLTS (Pink) and the SOCKET HEADS |
| | (Yellow). Make sure to tighten the flange |
| | bolt first, then the socket heads. One |
| | should tighten everything once the top and |
| | bottom scallops are in place to help make |
| | the assembly process easier. |
| 409 | Step 9 409 Put the guide rail in place |
| | between the bottom scallop and the drop |
| | funnels. |
| 410 | Step 10 410 Next install the drop funnels. |
| | From left to right there is the 100 funnel, |
| | 200 funnel, 300 funnel, and the 400 funnel. |
| | Each of these are held into place by small |
| | nobs. Take 200 funnel out first when taking |
| | the tooling off. One cannot get the 100 |
| | funnel out without taking the 200 funnel out |
| | first. When putting the tooling on, one |
| | should put the funnels on in numerical |
| | order. |
| 411 | Step 11 411 These bottle rail shelves are |
| | part of the drop funnel tooling. This is put |
| | up against the guide rail and are held in |
| | place by knobs. |
| 412 | Step 12 412 Adjust the cam slides. The |
| | height of the cam will be all the way down |
| | when running 100 and 200 ML. For 300 ML and |
| | higher, the height of the cam will be all |
| | the way up as far as it will go. |
| 413 | Step 13 413 Adjust the cam slides. The |
| | height of the cam will be all the way down |
| | when running 100 and 200 ML. For 300 ML and |
| | higher, the height of the cam will be all |
| | the way up as far as it will go. |
| 414 | Step 14 414 Adjust the cam slides. The |
| | height of the cam will be all the way down |
| | when running 100 and 200 ML. For 300 ML and |
| | higher, the height of the cam will be all |
| | the way up as far as it will go. |

The Scallop Feeder Bowl and Delivery System 30 for Necked Bottles and like objects is a highly versatile machine. The same base system may be changed in place to run various other bottles. For example, and not as a limitation, 50, 100, 200, 275/300, 1000, etc. can use a common system 30. Before the tool change occurs as shown in FIG. 18, a reverse deconstruction or dis-assembly occurs. As the parts are removed, they pare normally placed on roll-around carts to contain a set for a given bottle size and to be ready for the next processing of that sized bottle. The DISASSEMBLY PROCESS is:
Step 1: Lockout, tag out. Electrical panel and air housing.
Step 2: Remove necessary exterior panels.
Step 3: Remove the bottle rail shelves by using the knobs. Start by working one's way from the discharge to the shelves, then to the drop funnels, ending with 100. One cannot get the 100 funnel out without taking the 200 funnel out first.
Step 4: Remove the guide rail in place between the bottom scallop and the drop funnels.
Step 5: Remove the FLANGE BOLTS that are connecting the top and bottom scallops. These bolts will be taken out completely.
(One can loosen the socket heads that are in STEP 5, but do not take top scallop off.)
Step 6: Once the flange bolts are removed, remove the bottom scallop from the machine. This bottom scallop needs to be taken off BEFORE the top scallop otherwise it will fall.
Step 7: Loosen the socket heads that are connecting the top scallop to the feeder. One is then able to slide the top scallop off the machine.
Step 8: Then remove the 8 INNER SEGMENT PLATES.

Many different uses are anticipated for the Scallop Feeder Bowl and Delivery System 30 for Necked Bottles and use for orienting other types of objects with a necked configuration and like objects. Some examples, and not limitations, for use include and are shown in the following Table E.

| ITEM | DESCRIPTION |
|---|---|
| 1 | Liquor bottles of in necked |
| | bottles in various sizes |
| 2 | Shampoo and body wash bottles in |
| | necked bottles in various sizes |
| 3 | Cleaning product for household |
| | cleaning in necked bottles in |
| | various sizes |
| 4 | Laundry detergents in necked |
| | bottles in various sizes |
| 5 | Automotive fluids in necked |
| | bottles in various sizes - oil, |
| | transmission, steering, etc. |
| 6 | Food products such as cooking oils |
| | in necked bottles in various sizes |
| 7 | Cola drinks and sport power drinks |
| | in necked bottles in various sizes |

With this description it is to be understood that the Scallop feeder bowl and delivery system 30 for necked bottles 100 and like is not to be limited to only the disclosed embodiment of product. The features of the present invention 30 are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. Various features and aspects of the disclosed embodiments can be combined with or substituted for one another to form varying modes of the disclosed inventions. Thus, it is intended that the scope of at least some of the present inventions herein disclosed should not be limited by the disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any embodiment, feature, or combination of features shown herein. This is true even if only a single embodiment of the feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed considering the number of recited significant digits and by applying ordinary rounding techniques.

The present invention contemplates modifications as would occur to those skilled in the art. While the disclosure has been illustrated and described in detail in the figures and the foregoing description, the same is to be considered as illustrative and not restrictive in character, it being understood that only selected embodiments have been shown and described and that all changes, modifications, and equivalents that come within the spirit of the disclosures described heretofore and or/defined by the following claims are desired to be protected.

What is claimed is:

1. A Scallop feeder bowl and delivery system (30) for a group of un-oriented, necked bottles (100), the system (30) made of durable materials with features for cleanability and comprised of:
a) a set of interchangeable upper parts; and
b) a set of interchangeable lower and supporting component parts
wherein the system is used for orienting other types of objects with a necked configuration and wherein the system is built with completely interchangeable pieces for multiple parts handling, the system results in a reduction of changeover time, labor, initial capital investments, floor space requirements, spare parts inventory, maintenance time, and waste and the system increases overall machine uptime/usage, productivity, quality and repeatability.

2. The Scallop feeder bowl and delivery system (30) for a group of un-oriented, necked bottles (100) of claim 1 wherein the set of interchangeable upper parts includes:
(a) a set of Upper Scallops which have interchangeable sections, and
(b) a set of Pre-scallop section which have interchangeable sections that allow for multiple parts unique to each bottle/object size.

3. The Scallop feeder bowl and delivery system (30) for a group of un-oriented, necked bottles (100) of claim 1 wherein the set of interchangeable lower and supporting parts includes:
(a) a set of Lower Scallops which have interchangeable parts,
(b) a set of custom drop funnel sections,
(c) a set of Extractor tooling sections, and
(d) a Steel ring inhibitor.

4. The Scallop feeder bowl and delivery system (30) for a group of un-oriented, necked bottles (100) of claim 1 wherein the durable materials are selected from the group consisting of an Acrylonitrile Butadiene Styrene (ABS), a high temperature Delrin RTM plastic, a 304 Stainless Steel, a FDA approved Acetal (Polyoxymethylene, POM), a Polyvinyl Chloride (PVC), a Polyethylene terephthalate(PETE or PET), a high temperature Polypropylene (PP) compounds, and a composite material.

5. The Scallop feeder bowl and delivery system (30) for a group of un-oriented, necked bottles (100) of claim 1 wherein the other types of objects are selected from the group consisting of liquor bottles of various sizes, shampoo and body wash bottles in various sizes, household cleaning product in bottles in various sizes, laundry detergents in necked containers in various sizes, automotive fluids in necked bottles in various sizes, food products and cooking oils in various sizes, and drinks and sport power drinks in necked bottles in various sizes.

6. A Scallop feeder bowl and delivery system (30) for a group of un-oriented, necked bottles (100), the system (30) made of durable materials of claim 1 wherein the features for cleanability are selected from the group consisting of a resistance to extreme hot water for quasi sterilization, a resistance to steam sprays for quasi sterilization, and a compatibility to commercial/industrial soaps for preparation.

7. A Scallop feeder bowl and delivery system (30) for a group of un-oriented, necked bottles (100), the system (30) made of durable materials with features for cleanability and comprised of:
a) a set of interchangeable upper parts including
(a) a set of Upper Scallops which have interchangeable sections and
(b) a set of Pre-scallop section which have interchangeable sections that allow for multiple parts unique to each bottle/object size; and
b) a set of interchangeable lower and supporting parts including—
(1) a set of Lower Scallops which have interchangeable parts,
(2) a set of custom drop funnel sections,
(3) a set of Extractor tooling sections, and
(4) a Steel ring inhibitor
wherein the system is used for orienting other types of objects with a necked configuration and wherein the system is built with completely interchangeable pieces for multiple parts handling, the system results in a reduction of changeover time, labor, initial capital investments, floor space requirements, spare parts inventory, maintenance time, and waste and the system increases overall machine uptime/usage, productivity, quality and repeatability.

8. The Scallop feeder bowl and delivery system (30) for a group of un-oriented, necked bottles (100) of claim 7 wherein the durable materials are selected from the group consisting of an Acrylonitrile Butadiene Styrene (ABS), a high temperature Delrin RTM plastic, a 304 Stainless Steel, a FDA approved Acetal (Polyoxymethylene, POM), a Polyvinyl Chloride (PVC), a Polyethylene terephthalate(PETE or PET), a high temperature Polypropylene (PP) compounds, and a composite material.

9. The Scallop feeder bowl and delivery system (30) for a group of un-oriented, necked bottles (100) of claim 7 wherein the other types of objects are selected from the group consisting of liquor bottles of various sizes, shampoo and body wash bottles in various sizes, household cleaning product in bottles in various sizes, laundry detergents in necked containers in various sizes, automotive fluids in necked bottles in various sizes, food products and cooking oils in various sizes, and drinks and sport power drinks in necked bottles in various sizes.

10. A Scallop feeder bowl and delivery system (30) for a group of un-oriented, necked bottles (100), the system (30) made of durable materials of claim 7 wherein the features for cleanability are selected from the group consisting of a resistance to extreme hot water for quasi sterilization, a resistance to steam sprays for quasi sterilization, and a compatibility to commercial/industrial soaps for preparation.

11. A process for a Scallop feeder bowl and delivery system (30) for a group of un-oriented, necked bottles (100), the process is comprised of the following steps:
Step 200: bottle (100) entry (200) from feeder conveyors (109);
Step 210: bottles (100) drop (210) to rigid disk (35);
Step 220: bottles (100) advance (220) across pre scallops (81) toward upper scallops (41);
Step 230: bottles (100) drop (230) into aperture (46) of upper scallop (41);
Step 240: bottles (100) drop (240) up righted, oriented 105 between lower scallops (51) into space (51S);
Step 250: up-righted, oriented bottles (105) continue drop 250 between lower scallops (51) to ring (63);
Step 260: oriented bottles (105) advance (260) through drop funnel (61);
Step 270: oriented bottles (105) advance (270) through extractor tooling (71); and
Step 280: oriented bottles (105) advance (280) from scallop feeder (31) to a next wash and/or fill machine
wherein the system is used for orienting other types of objects with a necked configuration and wherein the system is built with completely interchangeable pieces for multiple parts handling, the system results in a reduction of changeover time, labor, initial capital investments, floor space requirements, spare parts inventory, maintenance time, and waste and the system increases overall machine uptime/usage, productivity, quality and repeatability.

12. The process of the Scallop feeder bowl and delivery system (30) for a group of un-oriented, necked bottles (100) of claim 11 wherein the other types of objects are selected from the group consisting of liquor bottles of various sizes, shampoo and body wash bottles in various sizes, household cleaning product in bottles in various sizes, laundry detergents in necked containers in various sizes, automotive fluids in necked bottles in various sizes, food products and cooking oils in various sizes, and drinks and sport power drinks in necked bottles in various sizes.
